(19) United States
(12) Patent Application Publication
(10) Pub. No.: US 2011/0137701 A1
(43) Pub. Date: Jun. 9, 2011

(54) METHOD FOR VARYING RESOURCES AT A CALL CENTER BASED UPON PREDICTED CALL CENTER VOLUME

(75) Inventors: Alla TSIPENYUK, Woodbridge, CT (US); John H. Winkelman, Southbury, CT (US); John W. Rojas, Norwalk, CT (US); Kenneth G. Miller, Washington, DC (US); James R. Norris, JR., Danbury, CT (US)

(73) Assignee: Pitney Bowes Inc., Stamford, CT (US)

(21) Appl. No.: 13/011,383

(22) Filed: Jan. 21, 2011

Related U.S. Application Data
(63) Continuation of application No. 11/373,562, filed on Mar. 10, 2006.

(30) Foreign Application Priority Data
Mar. 17, 2006 (EP) 06738722.5

(51) Int. Cl. G06Q 10/00

(52) U.S. Cl. 705/7.22

(57) ABSTRACT

A computer method that is used to control call center volumes for a range of dates. The method involves utilizing previous mailing campaign and call center response data to determine when the mail arrives in the home and when a call center is contacted in response to information in the mail; predicting the call center volumes based initially on the previous campaign and call center response data and as the mailing campaign and call center responses progresses updating call center predictions based on current mailing campaign data; and determining in home mail volumes needed to control call center volumes.

### RELATED APPLICATIONS

The present application is a continuation of commonly-owned, co-pending U.S. patent application Ser. No. 11/373,562, filed Mar. 10, 2006, entitled “METHOD FOR DYNAMICALLY CONTROLLING CALL CENTER VOLUME” (Attorney Docket No. F-986-04) assigned to Pitney Bowes Inc., of Stamford Conn. in the names of James R. Norris, Jr., John H. Winkleman, Kenneth G. Miller, John W. Rojas, and Alla Tsipenyuk which is incorporated herein by reference in its entirety. This Application claims the benefit of the filing date of U.S. Provisional Application No. 60/663,027 filed Mar. 18, 2005, which is also owned by the assignee of the present Application.

### CROSS REFERENCE TO RELATED APPLICATIONS

Reference is made to commonly assigned co-pending patent application Docket No. F-986-O1 filed herewith entitled “Method For Predicting When Mail Is Received By A Recipient” in the names of John W. Rojas, John H. Winkelman, Kenneth G. Miller, Alla Tsipenyuk and James R. Norris, Jr. Docket No. F-986-O2 filed herewith entitled “Method For Controlling When Mail Is Received By A Recipient” in the name of James R. Norris, Jr., John H. Winkleman, Kenneth G. Miller, John W. Rojas and Alla Tsipenyuk. Docket No. F-986-O3 filed herewith entitled “Method For Predicting Call Center Volumes” in the names of Kenneth G. Miller, John H. Winkleman, John W. Rojas, Alla Tsipenyuk and James R. Norris, Jr. Docket No. F-986-O5 filed herewith entitled, “Method for Determining the best Day of the week For a Recipient to receive a mail piece,” in the names of John H. Winkleman, John W. Rojas, Kenneth G. Miller, Alla Tsipenyuk and James R. Norris, Jr.

### FIELD OF THE INVENTION

This invention relates to anticipating call center volume and applying resources, e.g., staffing, commensurate therewith.

### BACKGROUND OF THE INVENTION

Companies have used the mail to sell products to customers for almost as long as there has been mail. Responses from these solicitations happen over multiple channels such as by phone, mail, fax, internet, email. Etc. Response volumes are tied to the mail volumes of direct marketing campaigns. Response volumes associated with a direct marketing campaign will usually have peak and the peak happens at some period of time after the direct marketing campaign has been mailed. Response peaks that happen via mail, fax, internet and email can be handled over multiple days. Response peaks that happen through calls can not, they must be handled in a timely manner or else the caller will hang up. Sometimes peaks in response volumes will overwhelm a call center and the call will not be handled in a timely manner. When this happens potential orders are lost.

A direct marketing campaign is divided into two parts. The first part is the planning, creation and execution of the campaign and the second part is handling the responses and orders associated with the campaign. There is normally a strong coupling between the response and order data from a previous campaign and the planning of the current campaign. There is normally a weak coupling between the execution of the campaign and the handling of the responses for that campaign. This weak coupling is partly due to there not being accurate data that can determine when response volumes associated with a direct marketing campaign will happen. Usually rules of thumb are used to tie response volumes to mailing drop dates, but the problem is that responses are more closely associated with when the recipient receives the mail piece, instead of when the mailing is dropped. Thus, the direct marketer is not able to confidently determine when the recipient who receives the mail piece will respond.

### SUMMARY OF THE INVENTION

This invention overcomes the disadvantages of the prior art by controlling call center volumes. The foregoing is accomplished by: determining a mailing campaign's required per day call center volumes; determining the expected and then actual delay from when a mail piece arrives to when a call response is received for previous and the current campaign using response delay algorithm; determining the expected and then actual call campaign response rate for the previous and the current campaign; determining in home mail volumes needed to meet call center volume requirements; determining USPS induction schedule for mailing campaign and updating USPS induction schedule based on changing response delay, response rate and in home volumes.

Controlling call center volumes allows the call center management to allocate staffing resources, based on experience and skill, on a more permanent basis. The call center volumes can be leveled for the same amount per day for a constant staffing level. It can also be controlled to deal with changing staffing levels on a daily basis i.e., ten call center representatives are available on Monday, Tuesday, Wednesday, and five call center representatives are available on Thursday and Friday.

Having the best skilled call center staff assigned to handling inbound response calls will increase the number of conversions from responses to orders (conversion rate). An increase in conversion rate is also an increase in order rates.

Having sufficient call center staff at all times allows all calls to be handled in a timely manner thereby eliminating dropped calls. Since many calls lead to orders this will lead to an increase in orders, order rate and hence will reduce the cost per order.

An advantage of this invention is that it allows the call center management to dynamically allocate sufficient staffing resources, based on call center response prediction and actual call center responses.

An additional advantage of this invention is that it allows a call center to completely handle the call volumes for each day of a campaign. On peak days this can be done either by hiring temporary resources or taking resources from other areas, such as staff tasked with placing is doing follow up calls. On slow days call response staff can be allocated to other areas of the call center instead of the staff sitting idle. Increased productivity of call center staff directly correlates to an increase in profits.

A further advantage of this invention is that by having sufficient staff on peak days all calls can be handled in a timely manner thereby eliminating dropped calls.

### BRIEF DESCRIPTION OF THE DRAWINGS

FIG. 1 is a flow chart of a prior art direct mail marketing process

FIG. 2 is a flow chart showing how to predict recipient delivery distribution for a mailing;

FIG. 3 is a flow chart that generates the actual mail shipment induction date and triggers a prediction update.

FIG. 4 is a flow chart that loads facility conditions and status information and triggers prediction updates if changes are detected.

FIG. 5 is a actual vs. predicted in-home curve for controlled mailing.

FIG. 6 is a drawing showing the predicted vs. partial actual in-home curves for a controlled mailing.

FIG. 7A is a mailing facility condition plant report.

FIG. 7B is a mailing facility loading plant report.

FIG. 8 is a flow chart showing how to compile historic USPS container level delivery data.

FIG. 9A is a drawing showing curves generated for the Dallas Tex. BMC.

FIG. 9B is a drawing showing curves generated for the Denver Colo. BMC.

FIG. 9C is a drawing showing curves generated for the Los Angles Calif. BMC.

FIGS. 10A-10F is a table showing sample mail piece historic delivery times for the North Metro facility which is used to create container level data shown in step 1580 (FIG. 8).

FIGS. 11A-11D depicts sample data representative of the mailing container level data shown in step 1580 (FIG. 8) in tabular form.

FIG. 12 is a flow chart showing how to determine the in-home date for a mail piece.

FIGS. 13A-13B is a table of drop shipment appointment close out dates.

FIG. 14A is a flow chart of a Process for controlling a mailing campaign.

FIG. 14B—is a flow chart of an algorithm for controlling the mail.

FIG. 15 is a flow chart showing how to determine the best shipment induction date as used by the algorithm in FIG. 14B.

FIG. 16 is a flow chart showing how to predict daily call center volumes for a mailing.

FIG. 17 is a flow chart showing how to control daily in-home mail volumes in order to achieve daily call volumes.

FIG. 18 is daily response curve showing call center response delays associated with in home mail pieces.

FIG. 19 is a table showing the information in FIG. 18 in tabular form.

FIG. 20 is a table showing how the historical response delay curve is applied to the in home volume for each day in the mailing campaign.

FIGS. 21A and 21B depicts an offset in the data in FIG. 20 and then sums the in-home quantities and multiplies the sum by the response rate, which obtains the predicted calls per day.

FIGS. 22A and 22B depict a table illustrating call center control results for a hypothetical example.

FIGS. 23A, 23B and 23C depicts a table illustrating call center control, where call volumes are sustained for longer periods of time using multiple campaigns, or a single campaign that is divided into different periods.

FIG. 24 is a flowchart showing how call center volumes can be dynamically controlled in order to maintain desired call volumes throughout the length of a mailing campaign as illustrated in FIGS. 22A and 22B.

### DETAILED DESCRIPTION OF THE INVENTION

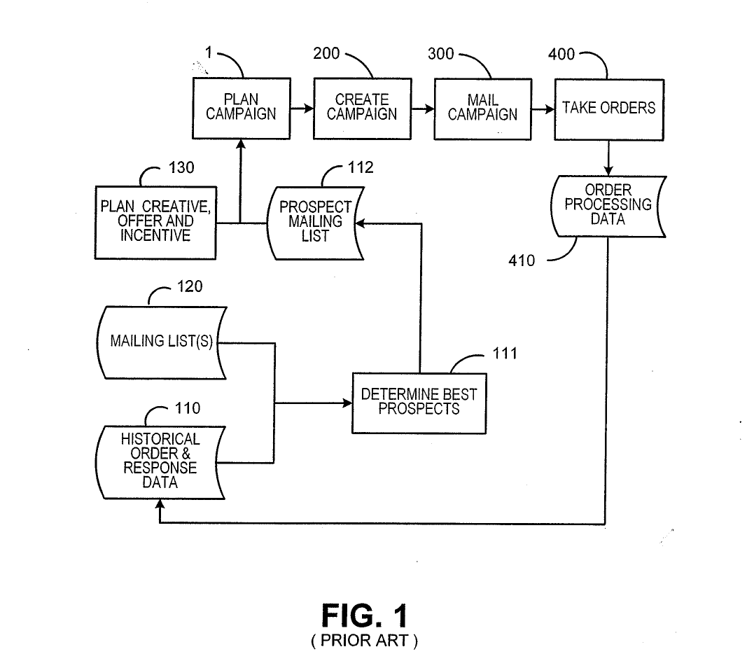

Referring now to the drawings in detail and, more particularly, to Prior Art FIG. 1, the process begins in step 1, where the direct mail marketer plans the campaign. Inputs into campaign planning include planning the creative, i.e., the design of the mail piece, offer and incentive in step 130 and acquiring mailing lists in step 120; then selecting prospects in step 112 by comparing respondent profiles in step 111 from different marketing tests, i.e., previous campaigns in step 110. Once the marketer has created the artwork, selected the prospects to be mailed from the lists available, the campaign is actually created in step 200. Step 200 involves having the various components of the mailing campaign printed, assembled and printing the addresses on the mail pieces and the address presorted. From there, the direct mail marketer mails, i.e., drop ships the mail to the appropriate USPS facility, the offer to all prospective customers in step 300. Once the prospective customers receive the offer, some prospects place orders in step 400. When the prospect orders, the direct mail marketer captures order processing data in step 410 and correlates the data with demographic information. That data is fed back into the order history database in step 110 and used to profile prospective customers for upcoming campaigns.

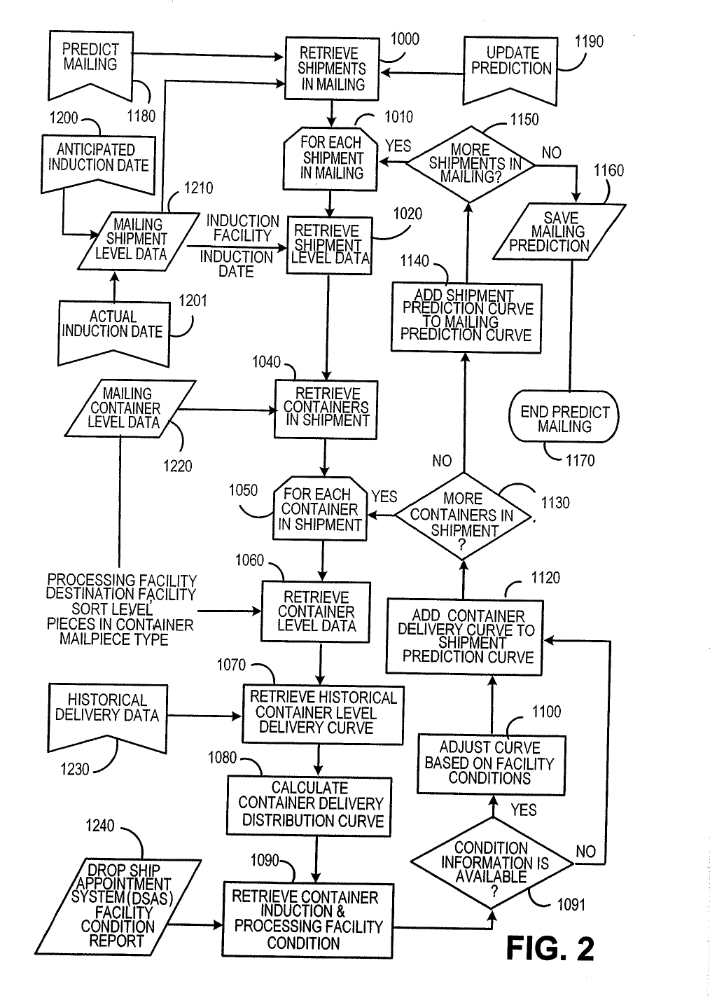

FIG. 2 is a flow chart showing how to predict recipient delivery distribution for a mailing. The process begins in step 1180 where the mailing prediction process begins and goes to retrieve shipments in mailing step 1000 or the process may also begin if it is triggered by the update prediction of step 1190. The anticipated induction date of the mailing from step 1200 is used with the retrieve shipment level data in step 1020 and with the mailing container level data from step 1220 by step 1210 to obtain the mailing shipment level data. Step 1020 uses mailing shipment level data from step 1210 including the anticipated induction date in step 1200 and the induction facility to prepare a prediction for a shipment. In step 1040 the containers in the shipment are retrieved. In step 1050 the process iterates through each container in the shipment and in step 1060 the process retrieves the container level data. Then the process will go to step 1070 to retrieve a historical container level delivery curve from step 1230. Then in step 1080 the container delivery distribution is calculated based upon the historical delivery curve by applying the container piece count for each day in the distribution and using Sundays, holidays and other postal delivery processing exceptions. Then in step 1090 the information from step 1080 and the drop ship appointment facility condition data from step 1240 is utilized to retrieve container induction and processing facility condition. Step 1091 determines whether or not the information from step 1240 is available. If step 1091 determines the information is available the next step in the process is step 1100 to calculate facility condition offset. If step 1091 determines the information is not available the next step in the process is step 1120.

Then step 1120 adds the container delivery curve to the shipment prediction curve. Then if step 1130 determines that there are no more containers in the shipment, the process goes to step 1140 to add a shipment prediction curve to a mailing prediction curve. If step 1130 determines that there are more containers in the shipment the next step will be step 1050. Now if step 1150 determines that there are no more shipments in the mailing the next step will be step 1160 to save the mailing prediction. If step 1150 determines that there are more shipments in the mailing the next step will be step 1010. Step 1170 ends the predict mailing process.

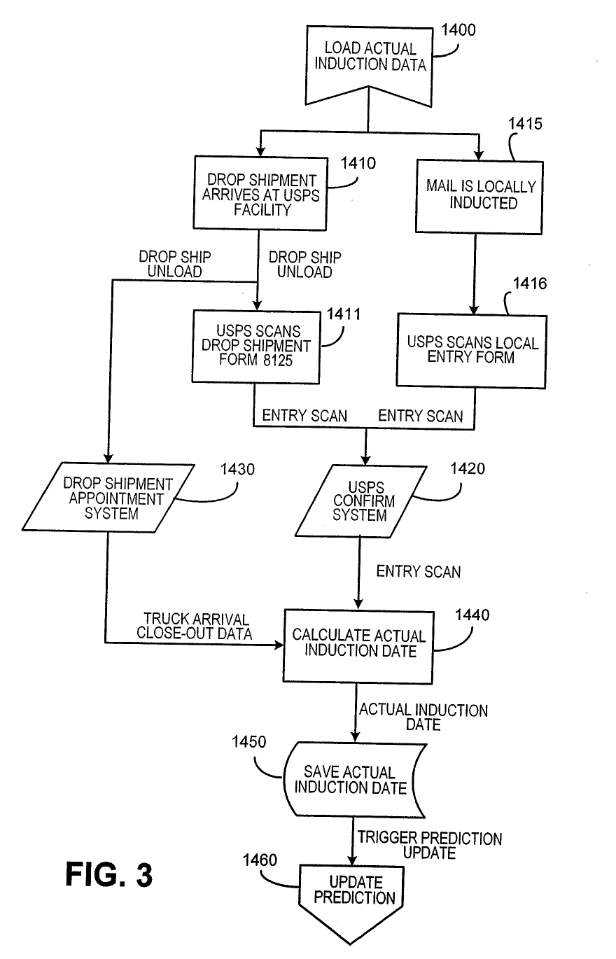

FIG. 3 is a flow chart that generates the actual mail shipment induction date and triggers the prediction update. The process begins at step 1400 via an automated or user driven request. Two independent events are detected, in step 1410, mail arrives at a USPS facility as a Drop Shipment and in step 1415, mail arrives at a USPS facility for local induction. Step 1411 follows step 1410 where the USPS scans Drop Shipment Form 8125 and produces an Entry Scan. Step 1416 follows step 1415 where the USPS scans Local Entry Form 3602 and also produces an Entry Scan. The Entry Scans are stored in Step 1420 by the USPS Confirm System for later retrieval. In addition, step 1410 is also followed by step 1430, where the Drop Shipment Appointment System stores information associated with the drop shipment, such as the truck arrival, status, load time, etc. Step 1420 and step 1430 are followed by Step 1440, where the Actual Induction Date is calculated using the best possible date from the entry scan or the drop shipment information that is available (If both sets of data are available, the appointment data is used). Then in step 1450 the Actual Induction Date is stored and in step 1460 a trigger is generated to update the mailing campaign prediction.

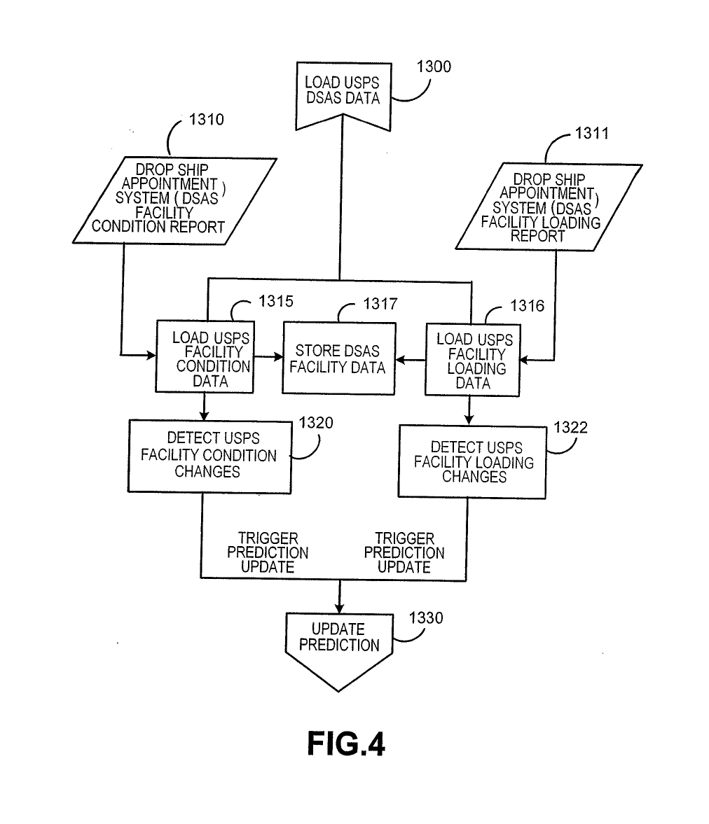

FIG. 4 is a flow chart that loads facility conditions and status information and triggers prediction updates if changes are detected. The process begins at step 1300, via an automated or user driven request. The facility conditions are then loaded in step 1315 from step 1310 and stored in step 1317. At the same time, Facility Loading data is loaded in step 1316 from step 1311 and stored in step 1317. Step 1320 follows step 1315, where changes to the facility conditions are detected. In a similar fashion, step 1322 follows step 1316 and detects changes to the facility loading data. In either case, if changes are detected, steps 1320 and 1322 will trigger a Prediction Update in step 1330.

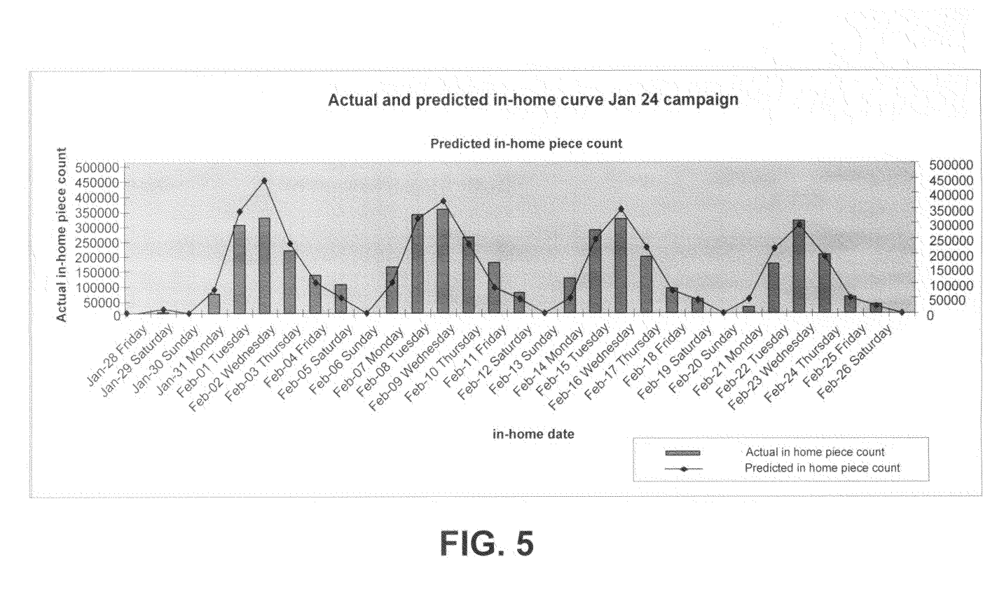

FIG. 5 is an actual vs. predicted in-home curve for controlled mailing.

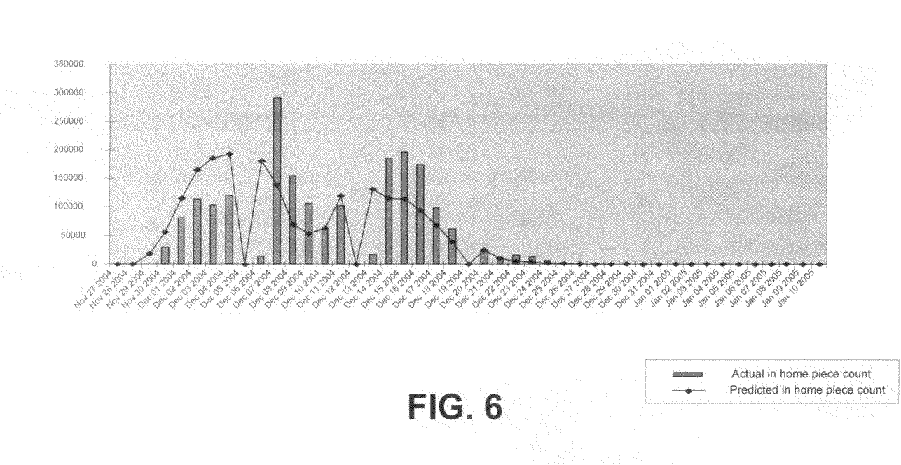

FIG. 6 is a drawing showing the predicted vs. partial actual in-home curves for a controlled mailing.

FIGS. 5 and 6 illustrate the variability encountered when dealing with high volume direct mail marketing campaigns through the standard approach of controlling drop dates (the date that the mail leaves the facility that created it).

In the case of FIG. 6 the mailer elected to create the mail all at once then drop the 4.5 million or so pieces over 3 days. The result was an elongated bell curve. The resultant impact was that the inbound call center, where the prospect called to order the item, could not handle the call volume. To remediate the situation, the mailer decided to go to a 4 week induction schedule, targeting Tuesday, Wednesday and Thursday for receipt of most of the mail for each week as shown in FIG. 5, where the mailer elected to drop the mail over a four (4) week period. The expected result was that ¼ of the mail would arrive each week for a period of four weeks. The mail control module was used to create the induction plan and the result was as seen in FIG. 5. By knowing the daily in-home piece count for the mail and understanding the likely response to those volumes the mailer was able to staff the call center correctly and the result yielded a higher order conversion rate for each inbound call.

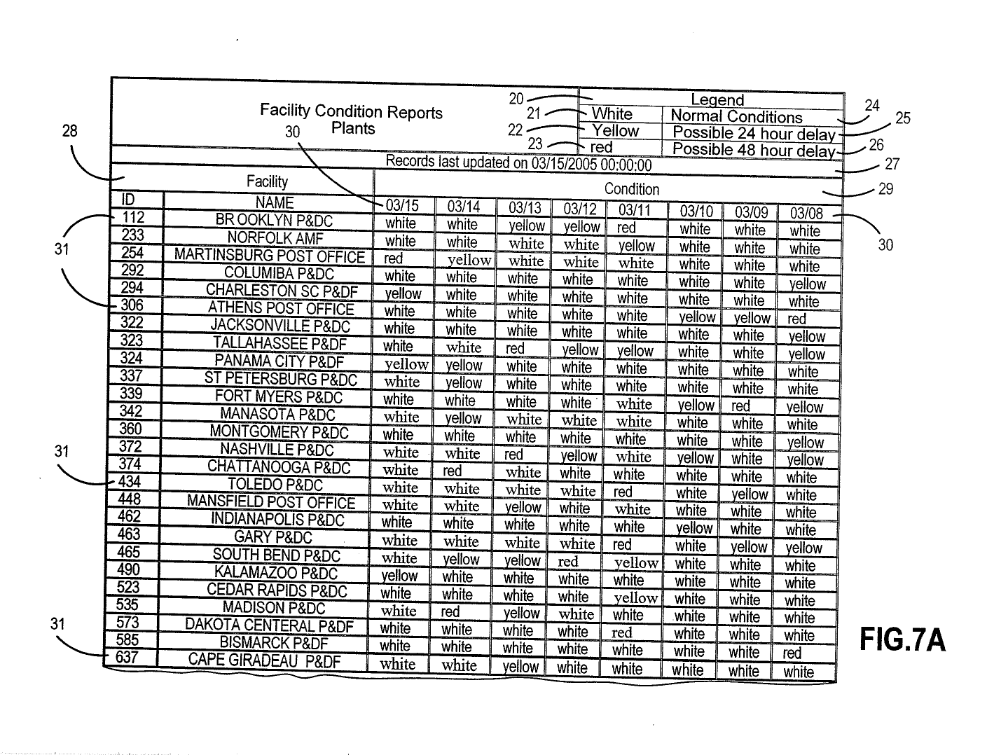

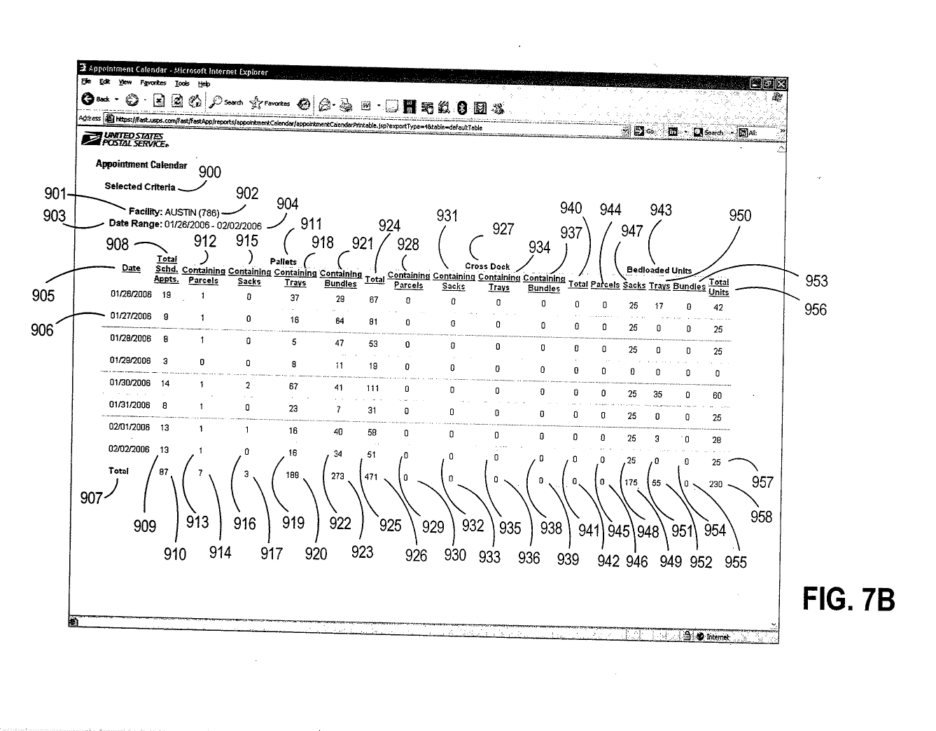

FIG. 7A is a mailing facility condition plant report. Block 20 is the legend block for the report. Spaces 21, 22 and 23 indicate the code used in the report. Space 24 indicates the condition represented by the code indicated in space 21 and space 25 indicates the condition represented by the code indicated in space 22. Space 26 indicates the condition represented by the code indicated in space 23. Space 27 indicates when the report was last updated. Column 28 indicates the facility name and column 29 indicates the condition of the facility indicated in lines 31 shown in rows 30 at the date indicated at the top of the column.

FIG. 7B is a mailing facility loading report that shows facility appointments over a date range. This report provides information on the amount or quantity of mail processed by a specific facility over time and the amount of mail that is scheduled to be processed by a facility in the near future. Space 900 is the header for the search criteria, including space 901 which is the Facility name header and space 902 which is the facility name. Space 903 is the Date Range header and space 904 is the date range for the report.

The data for the report is defined as follows. Space 905 is the column header for the Date and space 906 is date for each row of data. Space 907 is the row where the Totals are tallied for each column. Space 908 is the header for the Total Scheduled Appointments, and space 909 is the total appointments for each date, and space 910 is the total scheduled appointments for the facility over the date range specified in space 904, Date Range above. Space 911 is the header for the columns related to Pallets scheduled and space 912 is the column header for the total count of pallets containing parcels scheduled and space 913 is the count of pallets containing parcels scheduled for each day. Space 914 is the total count of pallets containing parcels scheduled for all days and space 915 is the column header for the total count of pallets containing bundles scheduled. Space 916 is the count of pallets containing bundles scheduled for each day and space 917 is the total count of pallets containing bundles scheduled for all days.

Space 918 is the column header for the total count of pallets containing trays scheduled and space 919 is the count of pallets containing trays scheduled for each day. Space 920 is the total count of pallets containing trays scheduled for all days. Space 921 is the column header for the total count of pallets containing bundles scheduled. Space 922 is the count of pallets containing bundles scheduled for each day and space 923 is the total count of pallets containing bundles scheduled for all days. Space 924 is the column header for the total count of pallets scheduled and space 925 is the total count of pallets scheduled for each day. Space 926 is the total count of pallets scheduled for all days and space 927 is the header for the columns related to cross docked mail scheduled. Space 928 is the column header for the total count of cross docked mail containing parcels scheduled and space 929 is the count of cross docked mail containing parcels scheduled for each day. Space 930 is the total count of cross docked mail containing parcels scheduled for all days and space 931 is the column header for the total count of cross docked mail containing bundles scheduled. Space 932 is the count of cross docked mail containing bundles scheduled for each day and space 933 is the total count of cross docked mail containing bundles scheduled for all days. Space 934 is the column header for the total count of cross docked mail containing trays scheduled and space 935 is the count of cross docked mail containing trays scheduled for each day. Space 936 is the total count of cross docked mail containing trays scheduled for all days and space 937 is the column header for the total count of cross docked mail containing bundles scheduled. Space 938 is the count of cross docked mail containing bundles scheduled for each day and space 939 is the total count of cross docked mail containing bundles scheduled for all days. Space 940 is the column header for the total count of cross docked mail scheduled and space 941 is the total count of cross docked mail scheduled for each day. Space 942 is the total count of cross docked mail scheduled for all days. Space 943 is the header for the columns related to bed loads scheduled and space 944 is the column header for the total count of bed loads containing parcels scheduled. Space 945 is the count of bed loads containing parcels scheduled for each day and space 946 is the total count of bed loads containing parcels scheduled for all days. Space 947 is the column header for the total count of bed loads containing bundles scheduled and space 948 is the count of bed loads containing bundles scheduled for each day. Space 949 is the total count of bed loads containing bundles scheduled for all days and space 950 is the column header for the total count of bed loads containing trays scheduled. Space 951 is the count of bed loads containing trays scheduled for each day and space 952 is the total count of bed loads containing trays scheduled for all days. Space 953 is the column header for the total count of bed loads containing bundles scheduled and space 954 is the count of bed loads containing bundles scheduled for each day. Space 955 is the total count of bed loads containing bundles scheduled for all days and space 956 is the column header for the total count of bed loads scheduled. Space 957 is the total count of bed loads scheduled for each day and space 958 is the total count of bed loads scheduled for all days.

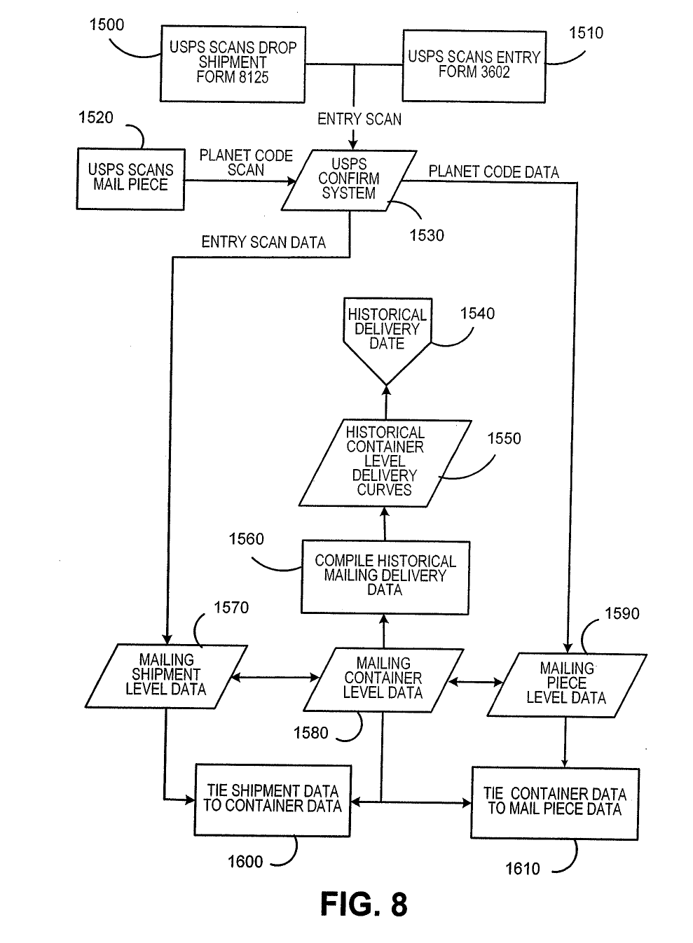

FIG. 8 is a flow chart showing how to compile historic USPS container level delivery data. The process begins at either step 1500 or step 1510. If the process began at step 1500 where the USPS scans drop shipment form 8125. Drop shipment form 8125 is used by the USPS for registering when the drop shipment arrives at a USPS facility. If the process began at step 1510 the USPS scans entry form 3062. Drop shipment form 3062 is used by the USPS for registering when mail is locally inducted by the USPS. In step 1530 the USPS confirm system is utilized. The confirm system receives the information scanned by the USPS from the mail piece in step 1520 and the information from steps 1500 and 1510. Then entry scan data from step 1530 is sent to step 1570 mailing shipment level data and planet code data is sent to step 1590 as mail piece level data. In addition drop shipment close out data is sent from the USPS Drop Shipment Appointment System (DSAS) to step 1570 as mailing shipment level data. In step 1580 mailing container level data is correlated from shipment level data tied in 1600 and mail piece level data tied in step 1610.

Step 1560 utilizes mailing container level data from step 1580 to compile historical mailing delivery data. Step 1550 utilizes historical mailing delivery data from step 1560 to produce historical container level delivery curves. Step 1540 stores the historical delivery data for predicting and/or controlling mailings

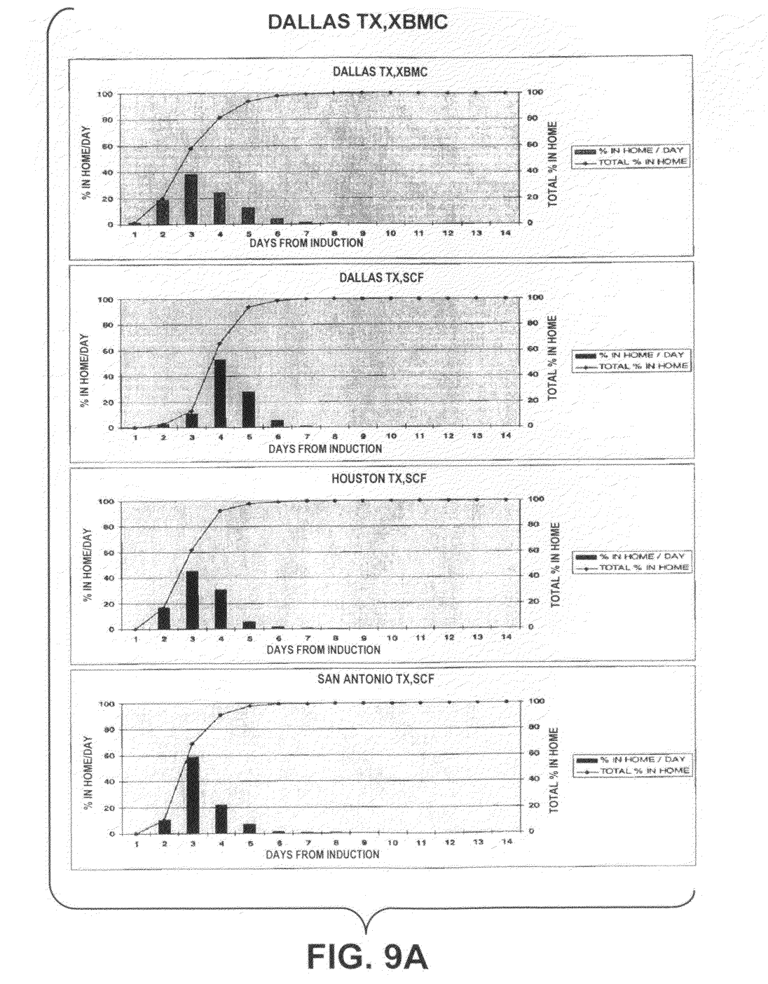

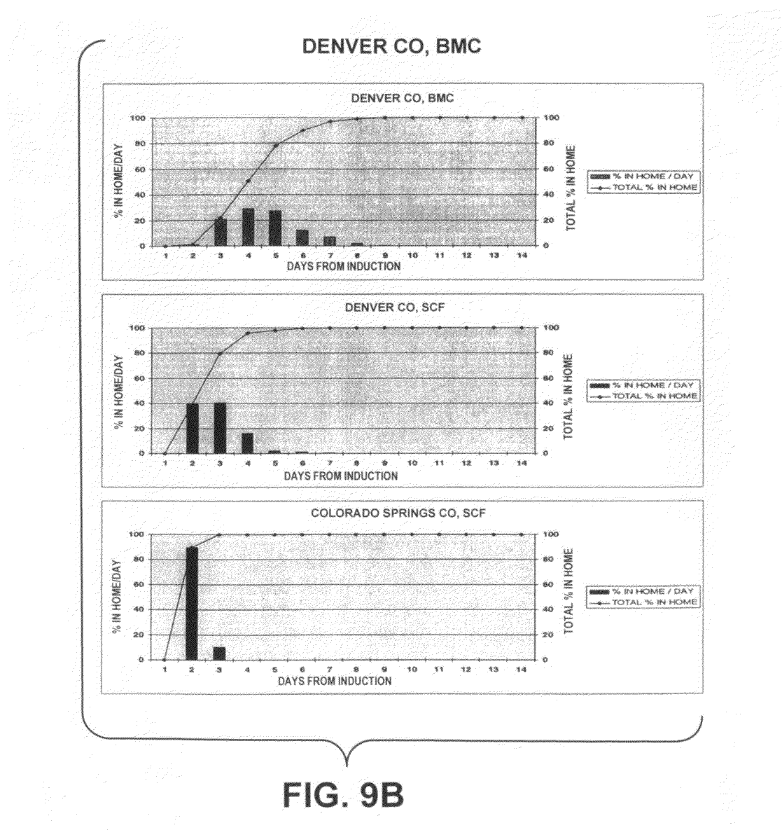

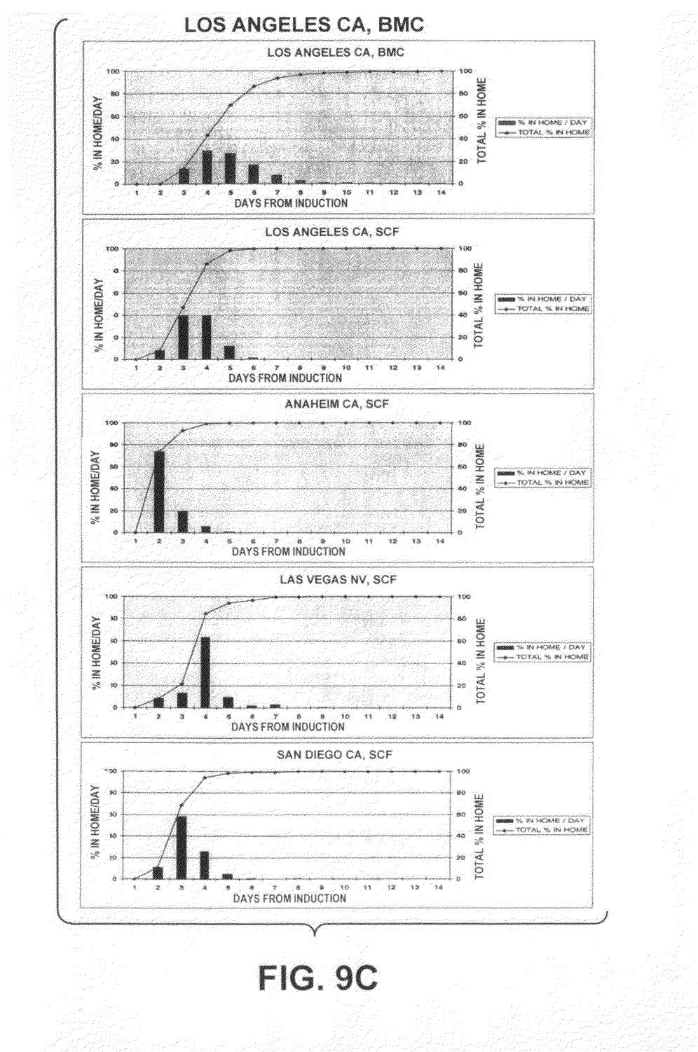

FIGS. 9A-9C show example curves generated for BMC's and SCF's in three different regions: Dallas Tex., Denver Colo., and Los Angeles, Calif. The curves show the high variability of in home mail distributions, both volumes and timing, across BMC and SCF in the same region. Furthermore, the figures also show the high variability across different BMC's and/or SCF across different regions.

Each of the FIGS. 9A-9C shows graphs for a specific facility, displaying average distribution of in home mail volumes from the day of induction to the day of delivery, over a 10 month period, January to October 2004. In each chart, the x axis is the number of days since induction and the y axis is the percentage of the mail delivered on that day.

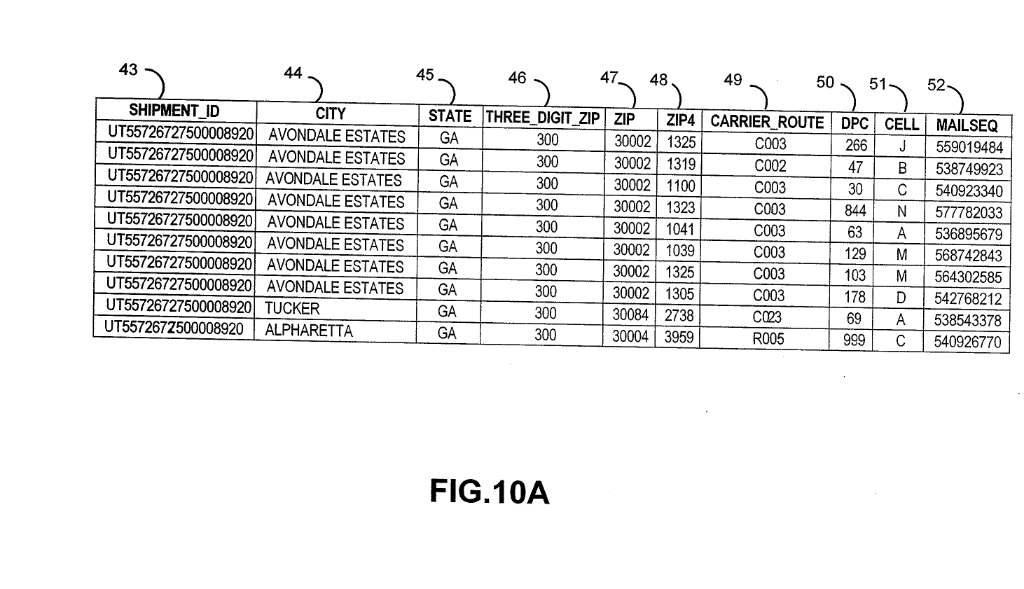

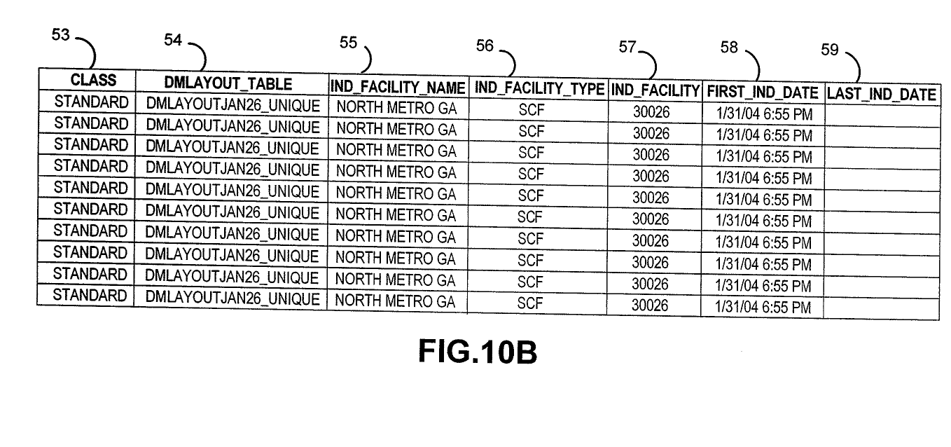

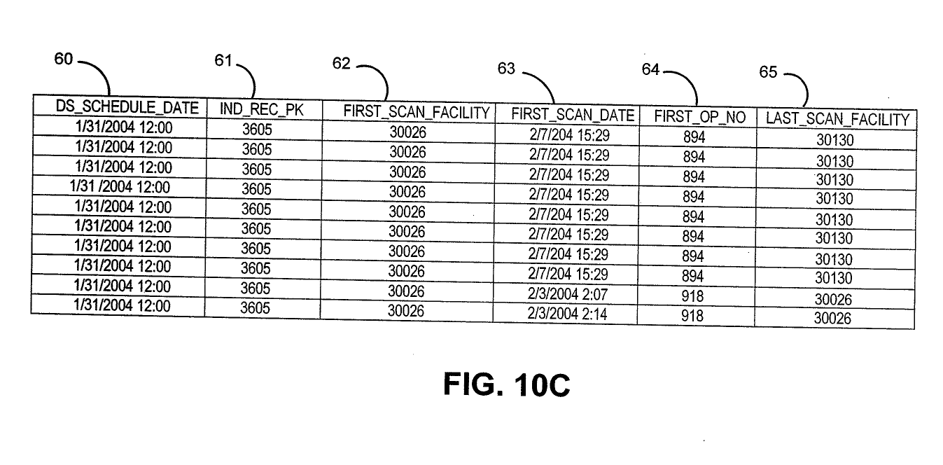

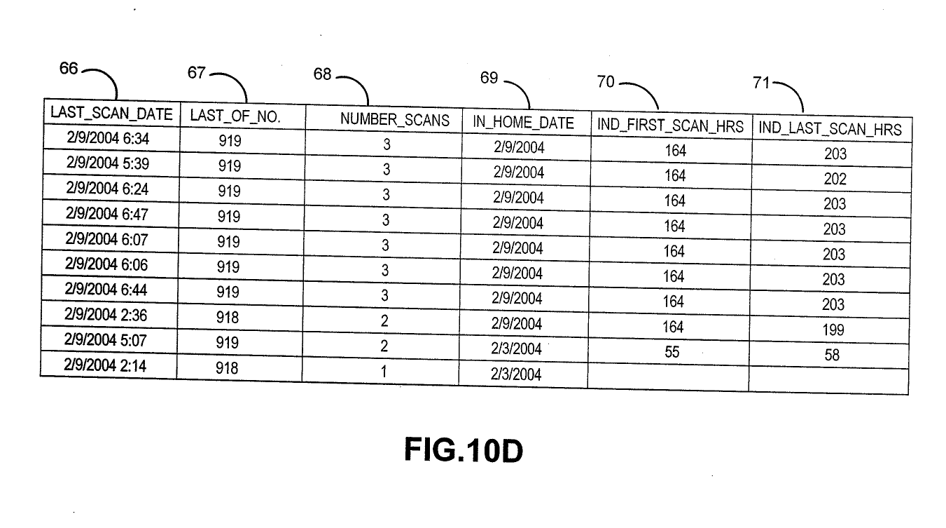

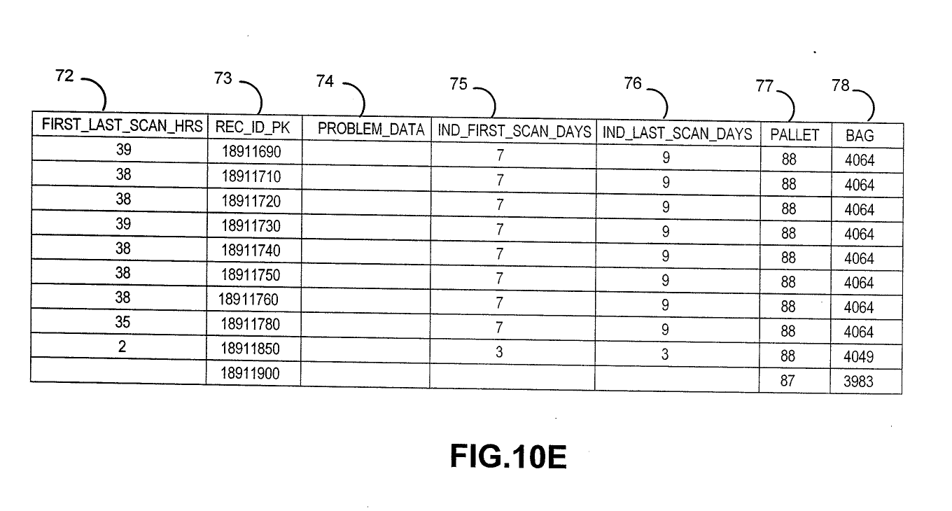

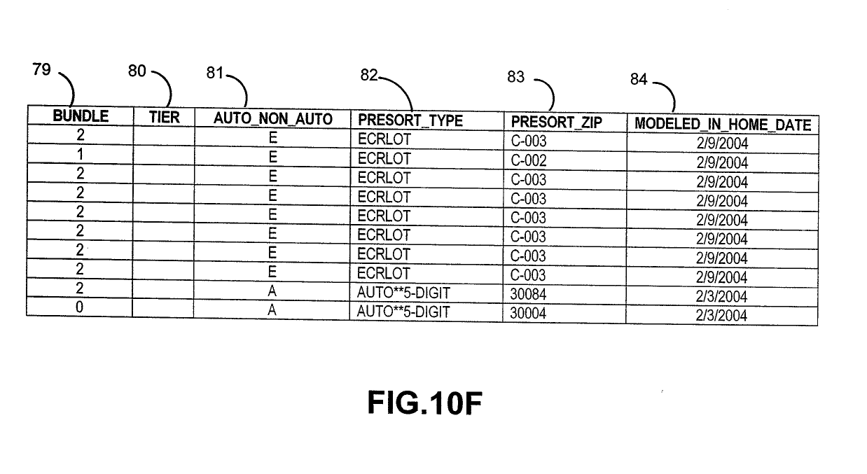

FIGS. 10A-10F is a table showing sample mail piece historic delivery times for the North Metro facility which is used to create container level data shown in step 1580 (FIG. 8).

In FIG. 10A the shipment ID, i.e., the identification of the mailing shipment is shown in column 43. The city and state that the shipment is delivered to is respectively shown in columns 44 and 45. The three digit zip code is shown in column 46. The zip code and the zip code plus four are respectively shown in columns 47 and 48. The carrier route for the shipment is shown in column 49. The delivery point code (DPC) is shown in column 50 and the cell i.e., identifies mail with different creative formats within a mailing is shown in column 51. The mail sequence i.e., internal/identifier for each mail piece is shown in column 52.

In FIG. 10 B the CLASS of mail is shown in column 53. Column 54 is the name DMLAYOUT_TABLE, the name of the table holding the address information for this mail piece. Column 55 (IND_FACILITY_NAME) holds the name of the induction facility. Column 56 (IND_FACILITY_TYPE) holds the type of facility, i.e. BMC, SCF, etc. Column 57 (IND_FACILITY) holds the zip code for the induction facility, and column 58 (FIRST_IND_DATE) is the time stamp of the first scan that occurs in the induction facility. Column 59 (LAST_IND_DATE) is the optional time stamp of the last scan that occurs in the induction facility.

In FIG. 10C column 60 (DS_SCHEDULE_DATE) is the date when the shipment was scheduled for drop shipment. Column 61 (IND_REC_PK) is a foreign key to the shipment record for this mail piece and column 62 (FIRST_SCAN_FACILITY) is the zip code of the facility where the mail piece was first scanned—after induction and column 63 (FIRST_SCAN_DATE) is the time stamp of the first scan at the processing facility. Column 64 (FIRST_OP_NO) is the operation that was performed on the mail piece during the first scan, i.e. first pass sort, second pass sort, etc. and column 65 (LAST_SCAN_FACILTY) is the zip code of the facility where the mail piece was last scanned.

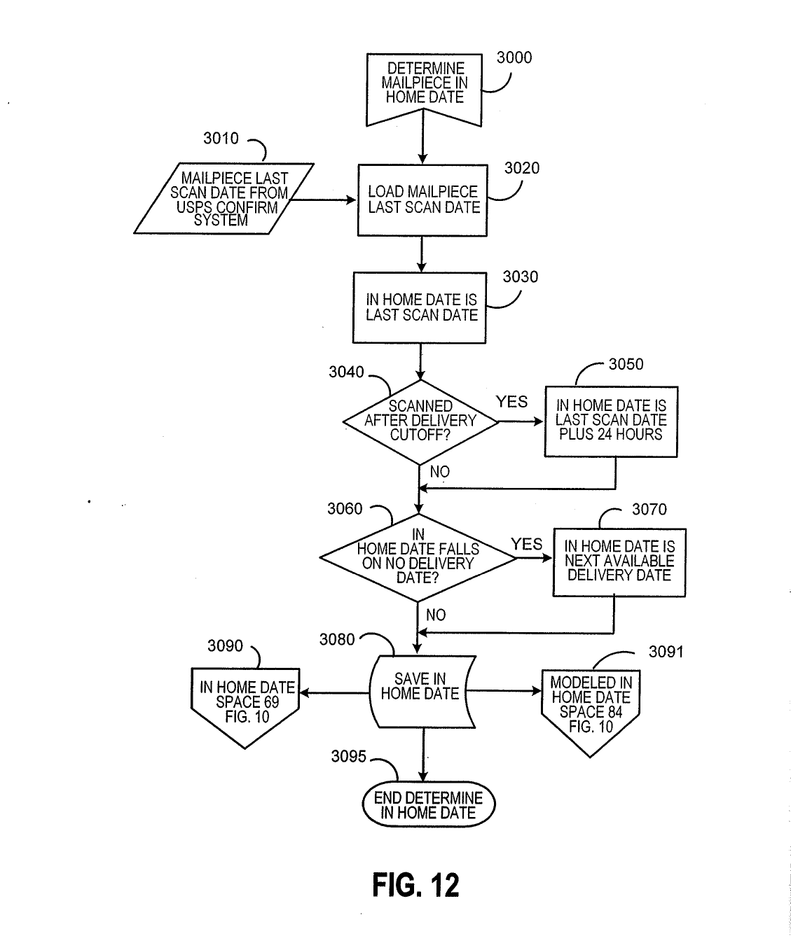

In FIG. 10D column 66 ((LAST_SCAN_DATE) is the time stamp of the last scan at a processing facility and column 67 (LAST_OP_NO) is the operation that was performed on the mail piece during the last scan. Column 68 (NUMBER_SCANS) is a count of the total number of planetcode scans (or operations) detected on the mail piece and column 69 (IN_HOME_DATE) is the calculated in home date for the mail piece, see FIG. 12. Column 70 (IND_FIRST_SCAN_HRS) is the number of hours between the FIRST_IND_DATE and the FIRST_SCAN_DATE and column 71 (IND_LAST_SCAN_HRS) is the number of hours between the FIRST_IND_DATE and the LAST_SCAN_DATE.

In FIG. 10E column 72 (FIRST_LAST_SCAN_HRS) is the number of hours between the FIRST_SCAN_DATE and the LAST_SCAN_DATE and column 73 (REC_ID_PK) is the primary key for this mail piece record. Column 74 (PROBLEM_DATA) is used to flag if there is problem data for this mail piece and Column 75 (IND_FIRST_SCAN_DAYS) is the IND_FIRST_SCAN_HRS represented as days. Column 76 (IND_LAST_SCAN_DAYS) is the IND_LAST_SCAN_HRS represented as days and column 77 (PALLET) identifies the pallet the mail piece is in for the mailing. Column 78 (BAG) identifies the bag the mail piece is in for the mailing.

In FIG. 10F column 79 (BUNDLE) identifies the bundle the mail piece is in Column 80 (TIER) i.e., C=carrier route, P=presort 3 or 5 digit, R=residential and column 81 (AUTO_NON_AUTO) indicates if the mail piece has an automation compatible post-net code, where A=zipcode plus 4 plus 2 and N=zip code. Column 82 (PRESORT TYPE) is the presort order assigned to the mail piece and column 83 (PRESORT_ZIP) is the zip code for the specific presort type in column 82. Column 84 (MODELED_IN_HOME_DATE) is the calculated in home date, see FIG. 12.

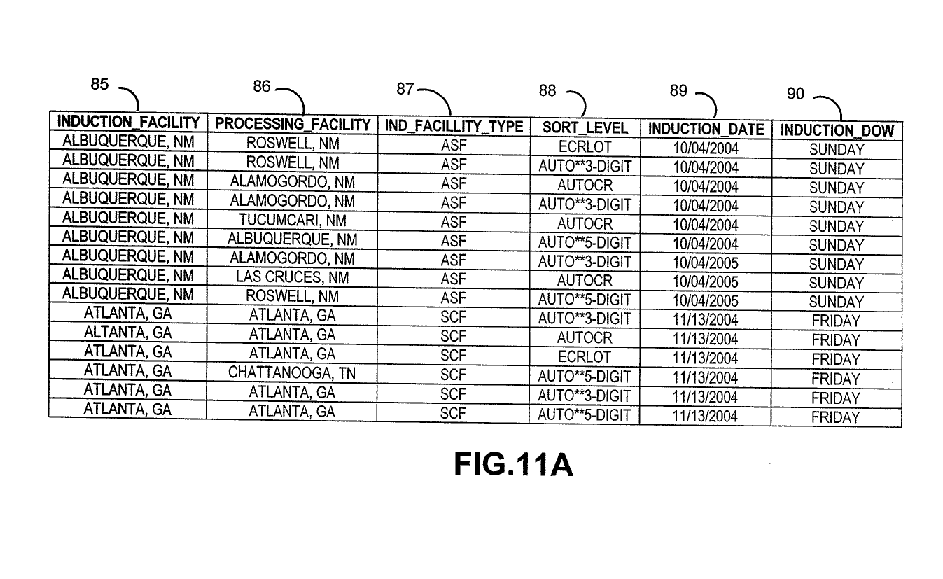

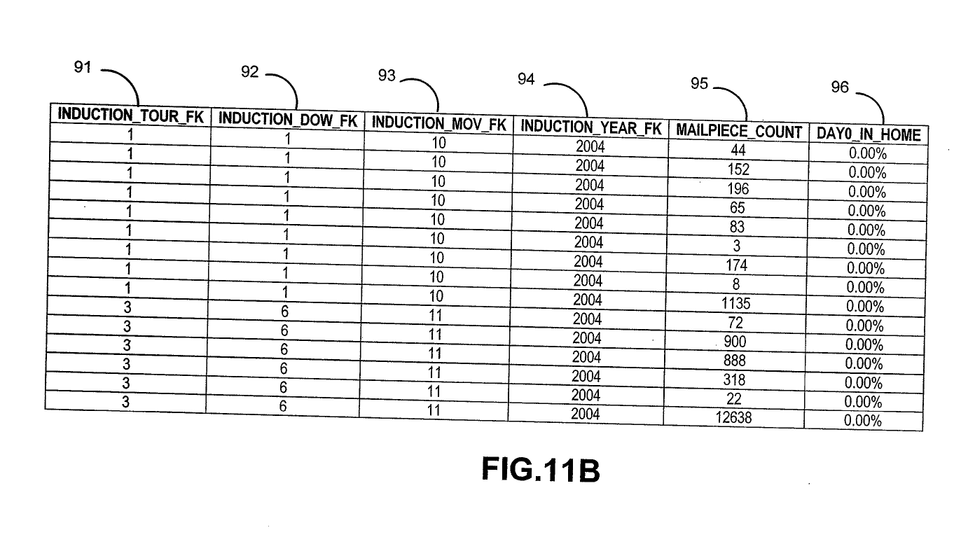

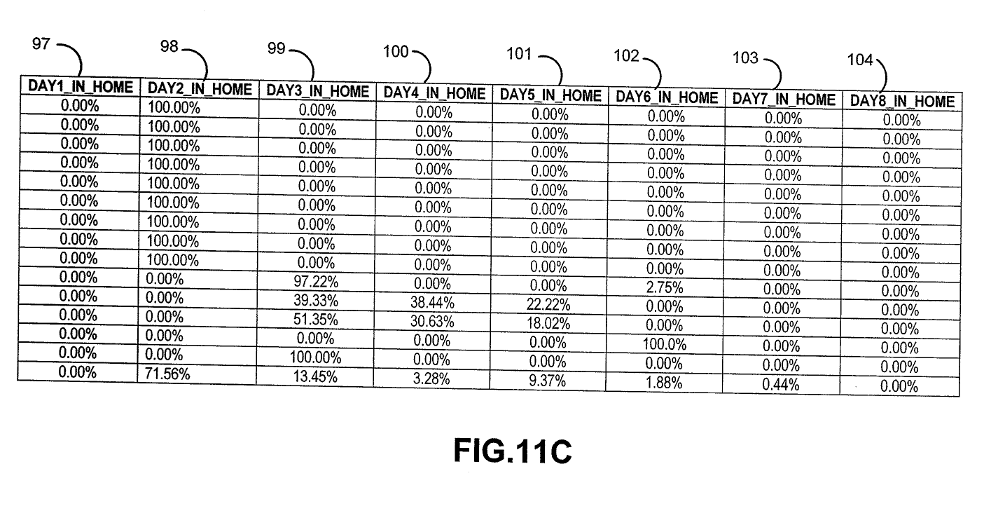

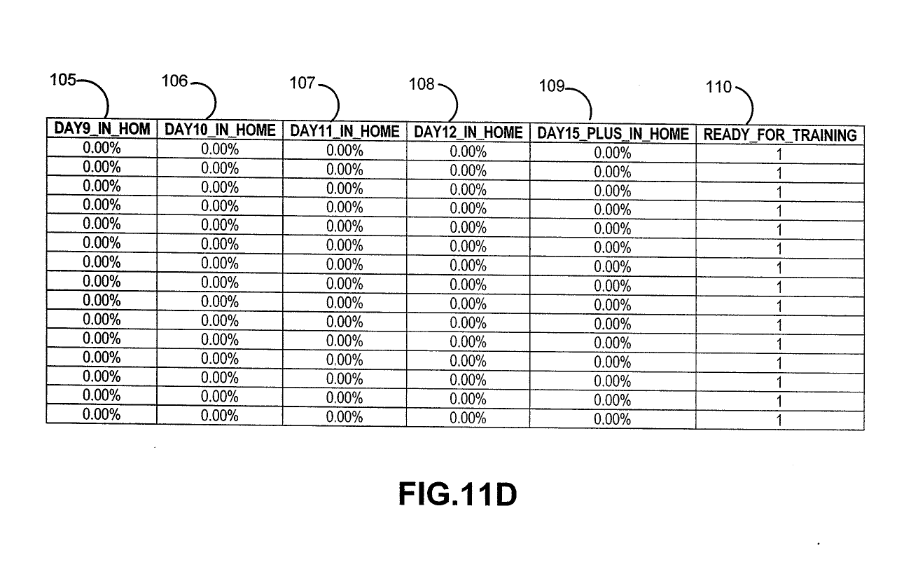

Mail piece level data (FIGS. 10A-10F) is combined or aggregated into container level data and tabulated as shown in FIGS. 11A-11D.

FIGS. 11A-11D depicts sample data representative of the mailing container level data shown in step 1580 (FIG. 8) in tabular form. In FIG. 11A the location of the induction facility for the mailing shipment is shown in column 85. Each row in FIGS. 11A-11D is representative of an aggregation of containers of mail pieces represented in rows in FIGS. 10A-10F (belonging to the container). The location of the processing facility of the mailing shipment is shown in column 86. The type of induction facility i.e., BMC, Auxiliary Sectional Facility (ASF) or SCF is shown in column 87. The sort level performed on the mail pieces, i.e., Enhanced Carrier Route (ECROLT), three digit sort level (AUTO**3-Digit), Auto Carrier Route (AUTOCR), five digit sort level (AUTO**5-Digit) are shown in column 88. The induction date of the shipment for the container is shown in column 89. The induction day of week (DOW) is shown in column 90.

In FIG. 11 B is the induction tour when the shipment was inducted Foreign Key (FK) for the container is shown in column 91 and the induction Day Of Week (DOW) for the container is shown in column 92. The induction MOY month of year (MOY) for the container is shown in column 93 and the induction year-FK for the container is shown in column 94. The mail piece count for the shipment is shown in column 95. The percentage of the container mail pieces that arrived on the induction day (Day0) In home is shown in column 96.

In FIG. 11 C the percent of mail pieces that are in the home one day after postal induction is shown in column 97 and the percent of mail pieces that are in the home two days after postal induction is shown in column 98. The percent of mail pieces that are in the home three days after postal induction is shown in column 99 and the percent of mail pieces that are in the home four days after postal induction is shown in column 100. The percent of mail pieces that are in the home five days after postal induction is shown in column 101 and the percent of mail pieces that are in the home six days after postal induction is shown in column 102. The percent of mail pieces that are in the home seven days after postal induction is shown in column 103 and the percent of mail pieces that are in the home eight days after postal induction is shown in column 104.

In FIG. 11D the percent of mail pieces that are in the home nine days after postal induction is shown in column 105 and the percent of mail pieces that are in the home ten days after postal induction is shown in column 106. The percent of mail pieces that are in the home eleven days after postal induction is shown in column 107 and the percent of mail pieces that are in the home twelve days after postal induction is shown in column 108. The percent of mail pieces that are in the home beyond the second week of postal induction is shown in column 109 and the ready for training flag shown in column 110 indicates when the record can be used as historical container level delivery curves as shown in step 1550 (FIG. 8).

FIG. 12 is a flowchart indicating how the In Home Date is calculated for a mail piece, and saved in space 69, IN_HOME_DATE, in FIG. 10D and is also used to calculate MODELED_IN_HOME_DATE in space 84 in FIG. 10F.

The process is applied to each mail piece that is scanned and starts in step 3000 and is followed by step 3020, where the last scan for the mail piece is loaded from step 3010, Mail piece Last Scan Date from USPS Confirm System. Next, step 3030 initializes the In Home Date for the mail piece as the Last Scan Date and then if step 3040 determines if the mail piece scan occurred after the delivery cut-off time for that facility, step 3050 will add 24 hours to the in home date, since the mail piece will not be delivered on the same day. Next if step 3060 determines that the In Home Date falls on a no-delivery date, such as a Sunday, Holiday, or exception date, etc, step 3070 will use the next available delivery date is used as the In Home Date for the mail piece.

The process continues at step 3080 where the calculated In Home Date is saved to space 69 in FIG. 10D, as shown in step 3090. Finally, the process ends in step 3095

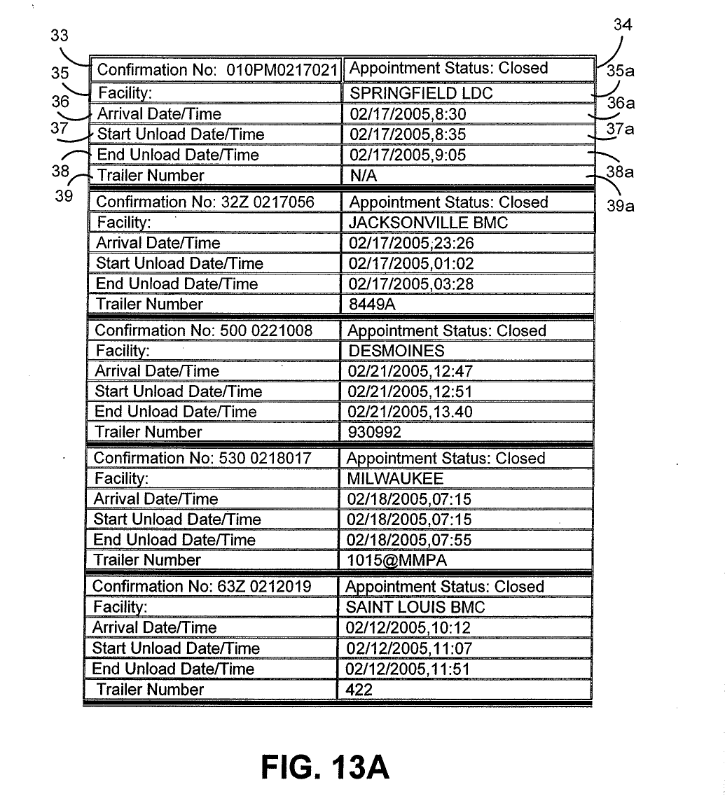

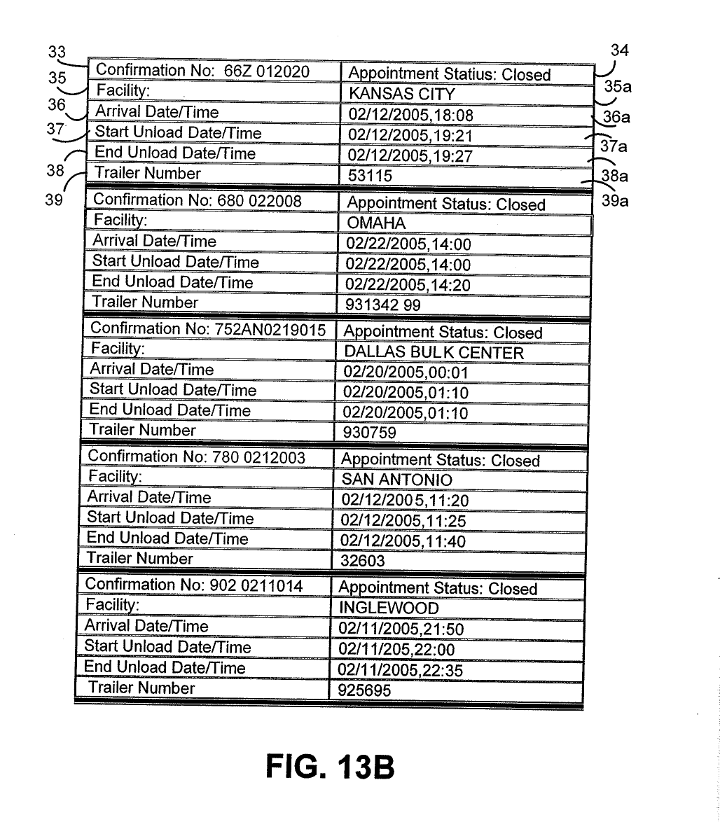

FIGS. 13A and 13B is a table of drop shipment appointment close out data, which is used to calculate the actual mail shipment induction date as described in FIG. 3. Space 33 indicates the shipment confirmation number and space 34 indicates the appointment status of the shipment, with states of Closed, No Show, or Open, etc. Space 35 indicates the header for space 35a, the name of the facility where the shipment is scheduled to arrive. Space 36 is the header for space 36a, the date and time when the truck arrived. Space 37 is the header for space 37a, the date and time when the truck started to be unloaded

Space 38 is the header for space 38a, the date and time when the truck completed unloading. Space 39a is the header for Space 39a, the Trailer Number, identifying the truck that delivered the mail.

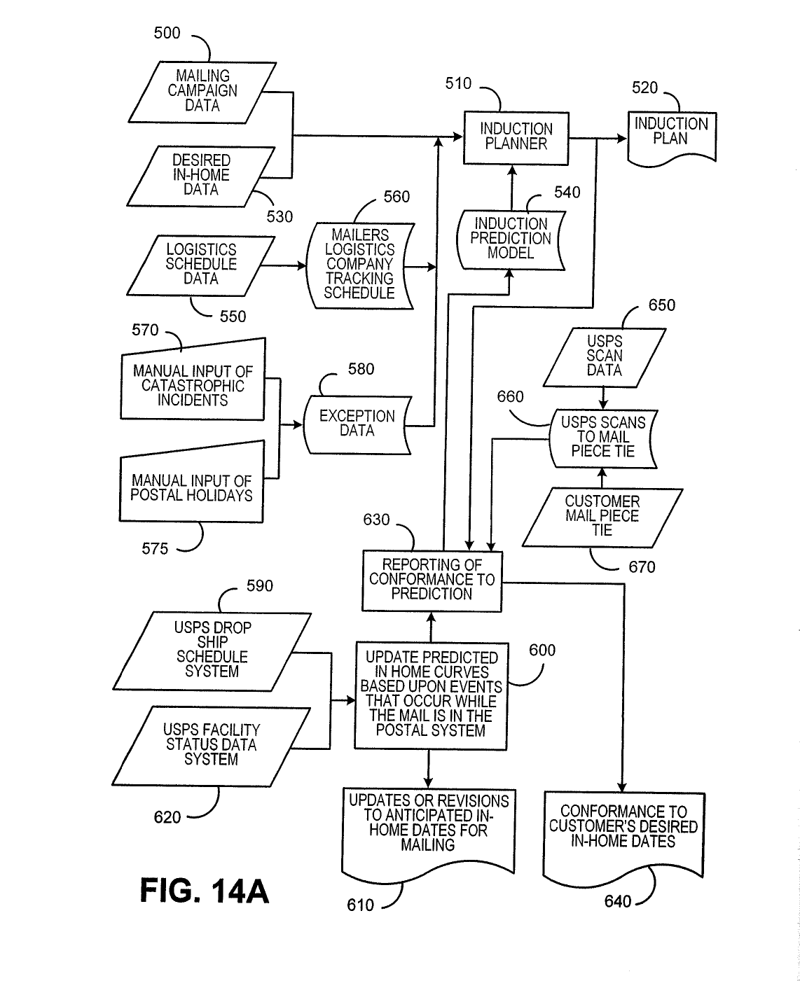

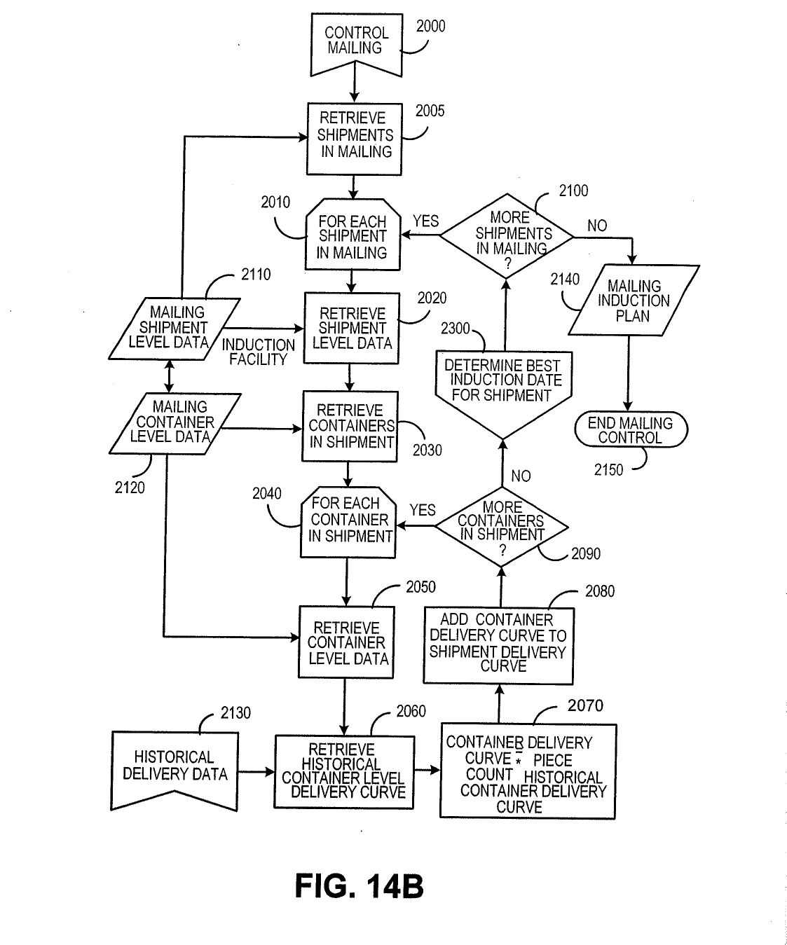

FIG. 14A is a flow chart of a Process for controlling a mailing campaign.

In FIG. 14 A, the customer provides mailing campaign data file in step 500 describing the mail pieces in each shipment of the mailing campaign. A mailing campaign consists of one or more shipments. Each shipment consists of a number of trays or containers of mail sorted to some density for instance 3-digit zip code level, 5-digit zip code level, or AADC level. Further, each shipment is to be inducted at a specific BMC of Sectional Control Facility (SCF). Each tray or container consists of one or more mail pieces. Of those mail pieces, one or more mail piece in each tray are uniquely identified with a bar code or bar codes uniquely identifying that mail piece. Those bar codes are in a format that is scanned and stored by the USPS. The mail campaign data include may custom formats such as a comma delimited flat file or an XML formatted data file, or may follow an industry standard such as Mail.dat. The customer also inputs to the system the desired days that the recipient is to receive the mail piece in step 530. The recipient target interval may be specific days of a week or specific dates. For instance, the recipient population is to receive the mail piece on a Tuesday or Wednesday or the recipient is to receive the mail piece on the 13^{th} or 14^{th} of January, 2005. The system shall accept inputs spanning one or more desired in-home days or dates.

The induction planner in step 510 using a model of the processing pattern of all facilities in the system determines the best day of the week to induct the mail at each of the target facilities. Step 510 is described in more detail in FIG. 14B. The system also accepts manual or automated exception event inputs containing postal holidays in step 575 and in step 570 catastrophic events that may shut down or seriously impede the postal system's ability to process mail. In step 580 the data is stored in an exception data file or database and accessed by the induction planner. Further, the system takes as an input the logistics schedule of the shipping provider for the mailer in step 550 and stores that data in step 560 using a method that allows access by the induction planning software. The logistics schedule of the shipping provider is the route schedule for that transportation firm. The system, is able to plan the induction schedule for the mail around the dates that the logistics provider actually inducts mail with the destination facility or facilities. It is not uncommon for the logistics providers to take mail to some facilities daily and some other facilities as infrequently as once per week.

Given all of the inputs, the system calculates an induction plan in step 510 containing the date to induct the mail for each destination facility within the USPS. Further, the system outputs an anticipated arrival curve for each container or shipment or the mailing campaign as a whole or a part of the campaign. The anticipated arrival curve provides the mailer with a realistic idea for when the mail will arrive with the recipient population given logistics constraints, postal processing variability, postal holidays and catastrophic events.

Once the mailer instructs the shipper when to induct the shipments at each destination processing facility the system monitors the USPS system in step 590 to measure when the shipment(s) were actually inducted. Step 590 is described in further detail in FIG. 3 and step 620 in described in further detail in FIG. 4. Additionally, the system monitors the DSAS system in step 620 for facility status information which may delay the processing and ultimately delivery of mail to the recipients of that mail. Periodically, the system accesses the stored induction and facility status data in step 600 and updates the anticipated in-home curves in step 610.

Once the mail is accepted, those pieces containing scannable bar codes are processed and tracked through the USPS. The USPS reports that scan information for each scannable piece. The scanned data in step 650 is downloaded to the system and tied to the customer mail piece data in step 670 through an appropriate database in step 660. The system then uses that data to generate reports containing when the prospect population is in fact receiving the mail pieces. Further that data is used to create conformance reporting back to the mailer in step 640 demonstrating how much mail was in-homed within the desired window.

The delivery results of the mailing campaign including shipment and mail piece information are then used to update the induction planning model in step 540 thus refining the induction planner's in step 510 future capability to accurately determine when mail is to be inducted to achieve desired delivery dates.

FIG. 14B is a flow chart of an algorithm for controlling the mail. The process begins in step 2000 control mailing. Then in step 2005 mailing shipments are retrieved from step 2110. Now in step 2010 each shipment from step 2005 is processed one shipment at a time. Then in step 2020 the data associated with the make up of the shipment from step 2110 is retrieved. The retrieved data includes the induction facility and the mail piece count. In step 2030 the identity of the containers in the shipment are retrieved from step 2120 mailing container level data.

Now in step 2040 each container in the shipment is processed. Then step 2050 the data associated with the make up of the container from step 2120 is retrieved. This data includes the container processing facility, destination facility, sort level, mail pieces in the container and make up of the mail piece. Then in step 2060 the historical level delivery curve associated with the container in step 2050 is retrieved from step 2130 historical delivery data. The historical delivery curve is conveyed as a proportional curve that indicates the percentage of mail pieces delivered each day.

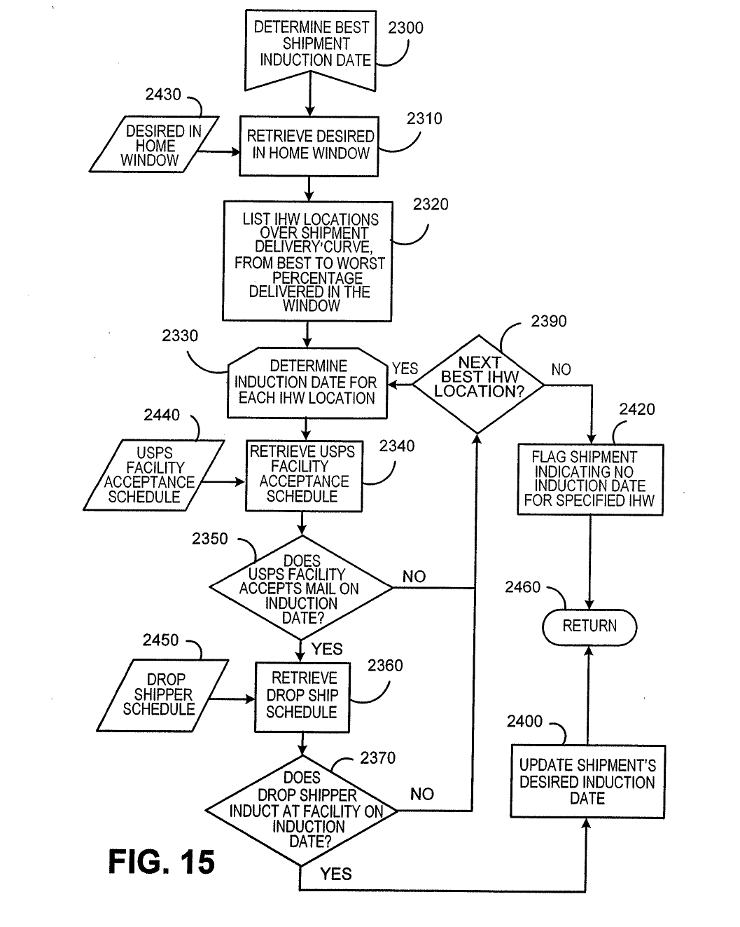

In step 2070 the mail pieces delivered per day for this container is calculated by multiplying the mail piece counts in the container by the historical container delivery curve. Then, step 2080 adds the container delivery curve calculated in step 2070 to the shipment delivery curve. Now step 2090 determines whether or not there are more containers to be processed in the shipment. If step 2090 determines there are more containers in the shipment to be processed, the next step will be step 2040. If step 2090 determines there are no more containers in the shipment to be processed, the next step will be step 2300 to determine the best shipment induction date. Step 2300 is more fully described in the description of FIG. 15.

Then the process goes to step 2100 to determine whether or not there are more shipments in the mailing campaign. If step 2100 determines that there are more shipments in the mailing campaign the next step is step 2010. If step 2100 determines that there are no more shipments in the mailing campaign the next step is step 2140 which prints an induction plan for execution. Now in step 2150 the mailing control algorithm is completed.

FIG. 15 is a flow chart showing how to determine the best shipment induction date as used by the algorithm in FIG. 14B. The process begins at step 2300 determine best shipment induction date. Then in step 2310 data is retrieved for the desired in home window. At this time data is exchanged between step 2310 and step 2430 desired in home window to specify the date range when most of the mail needs to be delivered. Now in step 2320 the process builds a list of all the possible in home window locations over the shipment delivery curve, calculating the percentage of mail delivered inside the window for each window location. The in house window locations are sorted from best to worst, i.e., from most mail delivered to least mail delivered in the window.

In step 2330, the induction date is determined for each in home window location taking into account Sundays and holidays. Then step 2340 retrieves the USPS facility acceptance schedule. Step 2340 exchanges information with step 2440 USPS facility acceptance schedule. At this point the process goes to step 2350. Step 2350 determines whether or not the USPS facility accepts mail on the induction date. If step 2350 determines that mail is accepted on the induction date, the process goes to step 2360 to retrieve the drop ship schedule. Step 2360 exchanges information with step 2450 drop shipper schedule. Then the process goes to step 2370. Step 2370 determines whether or not the drop shipper can deliver the shipment to the induction facility on the induction date. If step 2370 determines that the shipper can deliver the shipment on the induction date the process goes to step 2400 update shipment desired induction date. The next step will be step 2460 return. If step 2370 determines the drop shipper can not deliver the shipment on the induction date or if step 2350 determines that the USPS facility does not accept mail on the induction date then, the next step is 2390.

If decision step 2390, determines that the next highest in home window location does not exist, the process goes to step 2420, where the shipment is flagged as there is no known induction for the specified in home window. Then the process goes to step 2460 return.

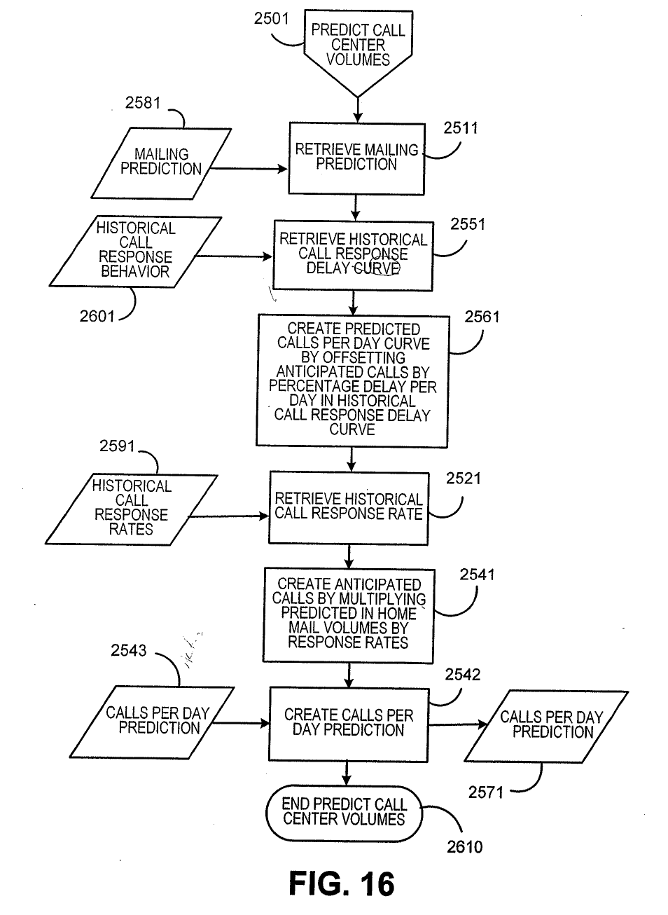

FIG. 16 is a flow chart showing how to predict daily call center volumes for a mailing. The process begins in step 2501, predict call center volumes. Then in step 2511, the mailing prediction is retrieved from step 2581, Mailing Prediction. The Mailing Prediction that is provided is an updated Mailing Prediction accounting for any known changes in the mailing campaign, including updated induction dates, facility status, etc. The updated Mailing Prediction is merged with the Actual In Home curve as it is determined to date; and gradually, predicted in home volumes are replaced with actual results. Therefore, the Mailing Prediction allows predicted call center volumes to be updated as the campaign progresses so that corrective action can be taken at the call center with staffing or resources if necessary. Now in step 2551, the historical call response delay curve is retrieved from step 2601, the historical call response behavior. The historical call response delay curve provides daily rates for responses to mail pieces arriving on a specific day; that is, some recipients will respond the day that the mail piece arrives, others on the next day, others two days later, and so on.

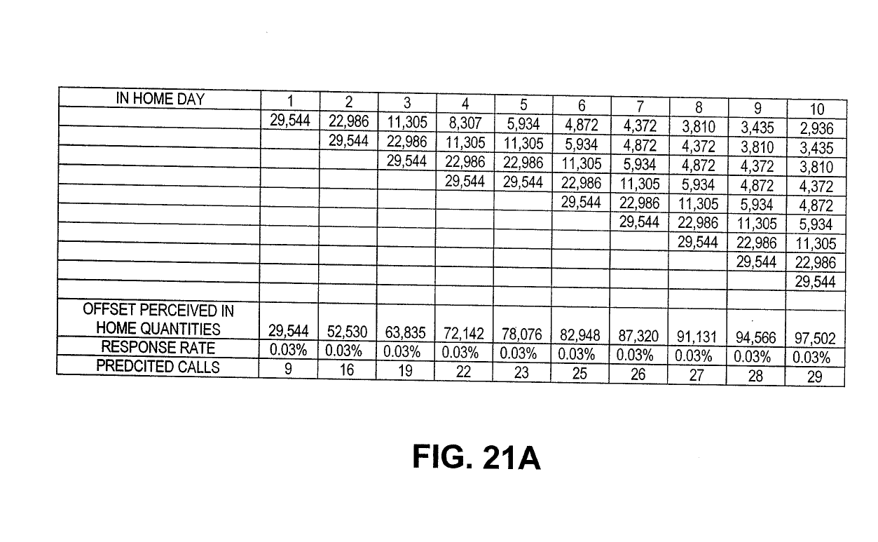

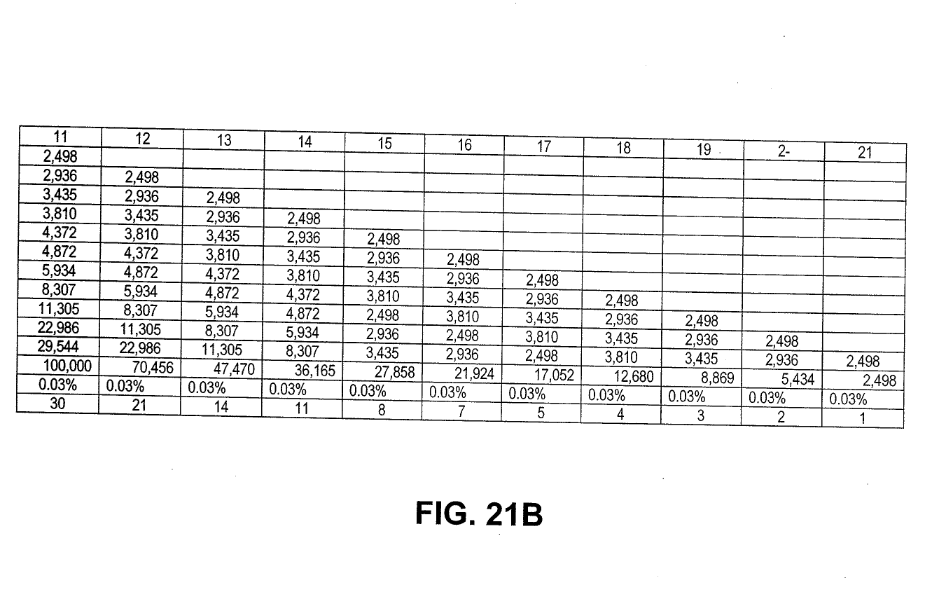

Now the process goes to step 2561, to calculate the predicted calls per day curve. The historical call response delay curve is applied to the mail pieces that were predicted to arrive on each day of the campaign. In other words, the mail pieces arriving each day are distributed across a range of days, based on the call response delay curve, in order to determine the call response delay distribution for that day. The predicted calls per day curve (i.e. call response delay distribution for the entire campaign) is calculated by adding the call response delay distribution for each in-home day of the campaign. See FIGS. 21A and 21B.

At this point, the predicted calls per day indicates that all of the recipients will respond to the mailing, the next step will scale the results by applying one or more historical call response rates. Now in step 2521, the historical call response rates are retrieved from step 2591, historical call response rates. Then in step 2541, anticipated calls are calculated by multiplying predicted calls per day by the response rate. Next in step 2542 create calls per day prediction will merge the anticipated calls calculated in step 2541 with the daily actual call volumes measured at the center in step 2543, by giving higher priority to the actual call results. Finally, in step 2571, the calls per day prediction is produced, based on the merged anticipated calls and actual calls that were calculated in steps 2541 and 2543 respectively. After producing the calls per day prediction, the process ends in step 2561 end predict call center volumes.

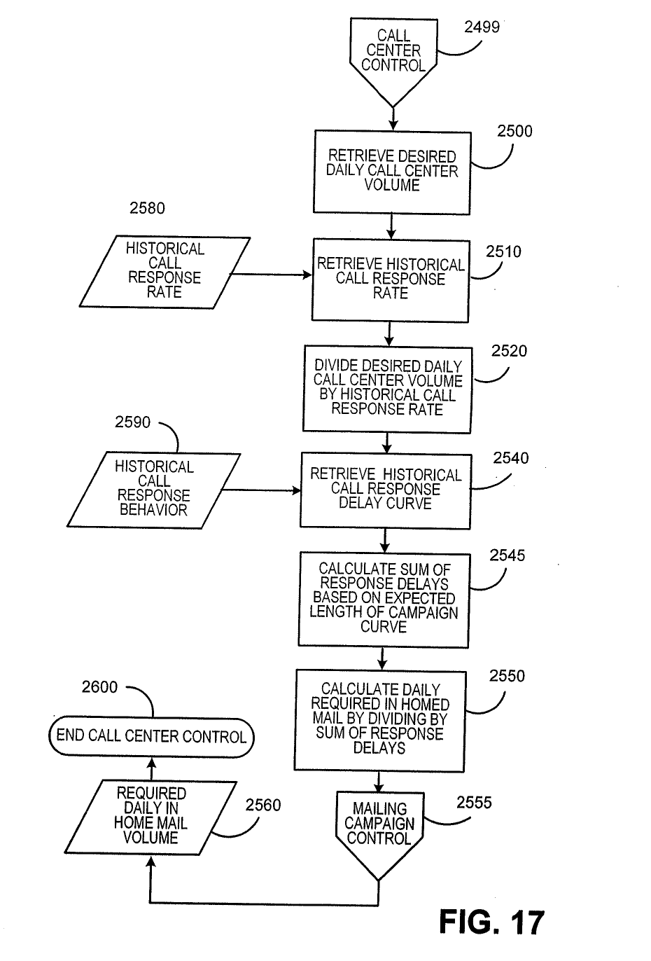

FIG. 17 is a flow chart showing how to control daily in-home mail volumes in order to achieve daily call volumes. The process begins in step 2499 call center control, then the process continues in step 2500, retrieve desired daily call center volume (how many call center calls do you want a day). Then the process goes to step 2510, to retrieve historical call response rate from historical call response rate, step 2580. Now the process goes to step 2520, divide desired daily call center volume by historical call response rate (desired responses per day). In step 2540, the historical call response delay curve is retrieved from step 2590, historical call response behavior. Then in step 2545, the process sums the response delays based on the length of the desired campaign in home window. In step 2550, the process calculates the required in home window mail volume, by dividing desired responses per day by the sum of the response delays. Now in step 2555 the mailing campaign control algorithm is executed to produce an induction plan that will generate the in home volumes that were calculated in step 2550. Step 2555 is described in further detail in FIG. 14B. Step 2555 will also take into account placing the in home volumes at the correct tome and date so that the required call volumes are generated when expected, i.e., if you want the call center volumes to peak on February 15^{th} to February 16^{th}, the peak mail volumes must arrive some time before February 16^{th}. Then in step 2560, the required daily in home mail volume curve is produced. Then step 2600 ends the call center control.

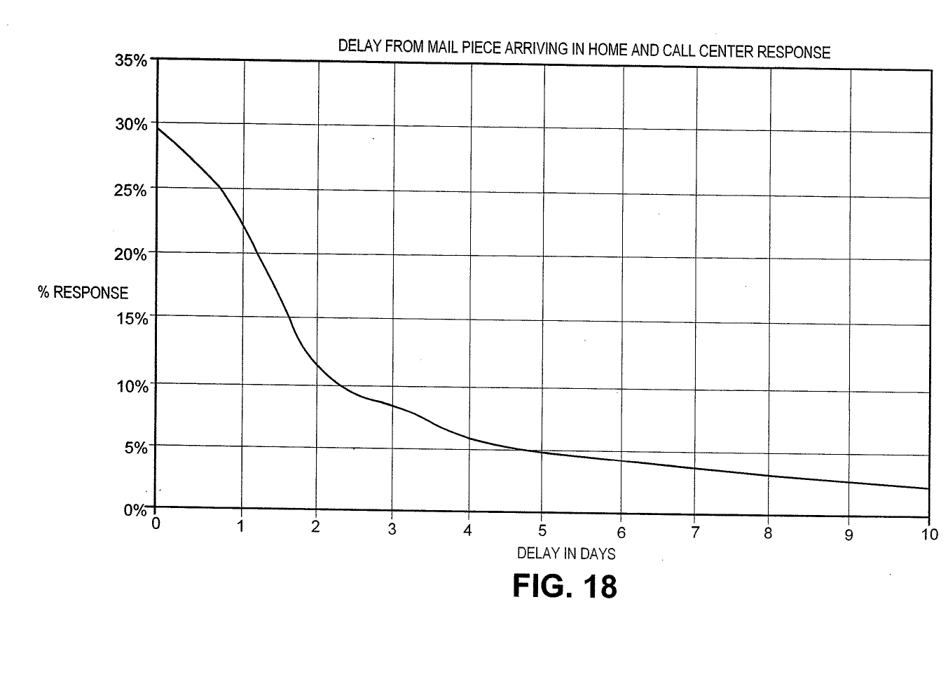

FIG. 18 is a daily response curve showing call center response delays associated with in-home mail pieces. The curve shows. the probability of a recipient responding X days after receiving a mail piece. The X axis is the number of days after receiving the mail piece and the Y axis is the likelihood that a recipient will respond on that day. This curve is applied in step 2561 of FIG. 16 to calculate the predicted distribution of calls for the mail pieces arriving on each one of the in-home days of a mailing. This curve can be further divided based on seasonality, day of week, geographical location, weather conditions, etc.

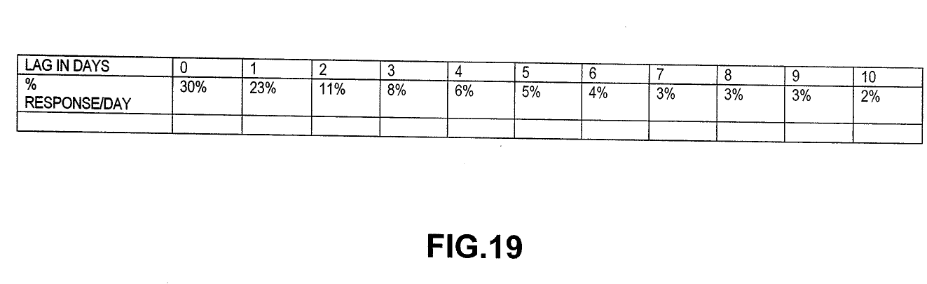

FIG. 19 is a table showing the information in FIG. 18 in tabular form. The table illustrates the percentage of respondents per day for mail pieces arriving in home on a given day. The historical response delay curve need not be limited to 10 days of delay, instead, it can long enough to account for a specific amount of responses, such as 90%.

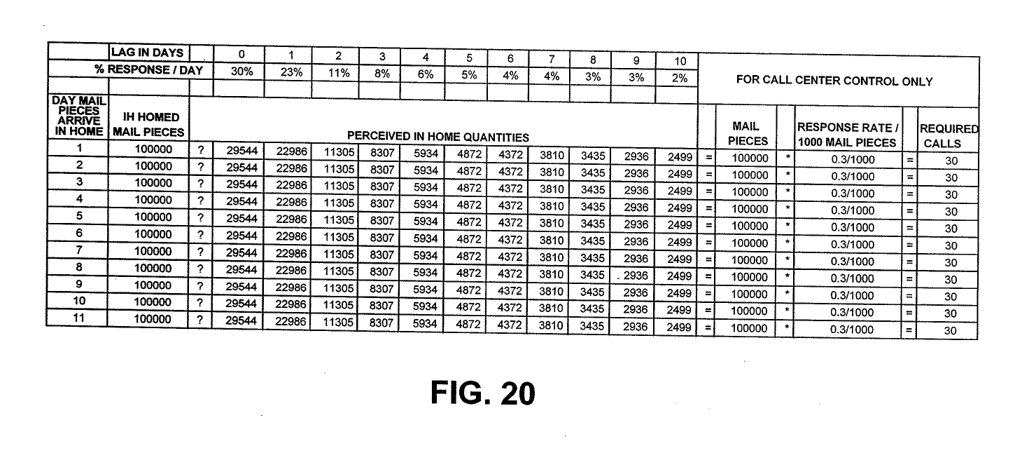

FIG. 20 is a table showing how the historical response delay curve is applied to the in home volume for each day in the mailing campaign. The rows in the table show the mail for each day in the mailing campaign, totaling 11 days, where 100,000 pieces arrived in home on each day. The columns in the table show the distribution of responses for each in home day, by applying the historical response delay curve. It is important to note though, that the delayed response volumes will need to be shifted based on the day when mail pieces arrived. This is explained in FIG. 21A and FIG. 21B.

FIGS. 21A and 21B depicts an offset in the data in FIG. 20 and then sums the in-home quantities and multiplies the sum by the response rate, which obtains the predicted calls per day. The rows are the same as shown in FIG. 20, except that they have been shifted so that the response distribution starts on the day when the mail pieces arrived, for each in home day. The 21 columns represent each day when calls are predicted to arrive into the call center, and the response rate is used to calculate the predicted number of calls for each day in the predicted response curve. The table uses a sample response rate of 0.03%, but in application, the response rate can be applied based on historical analysis, for example, based on day of week, geographical location, weather, etc.

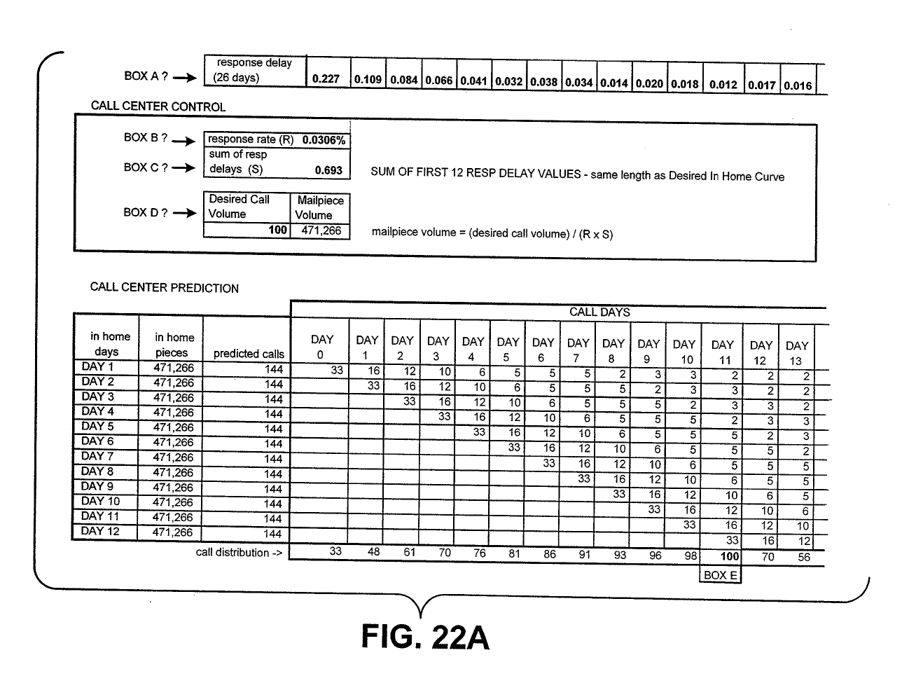

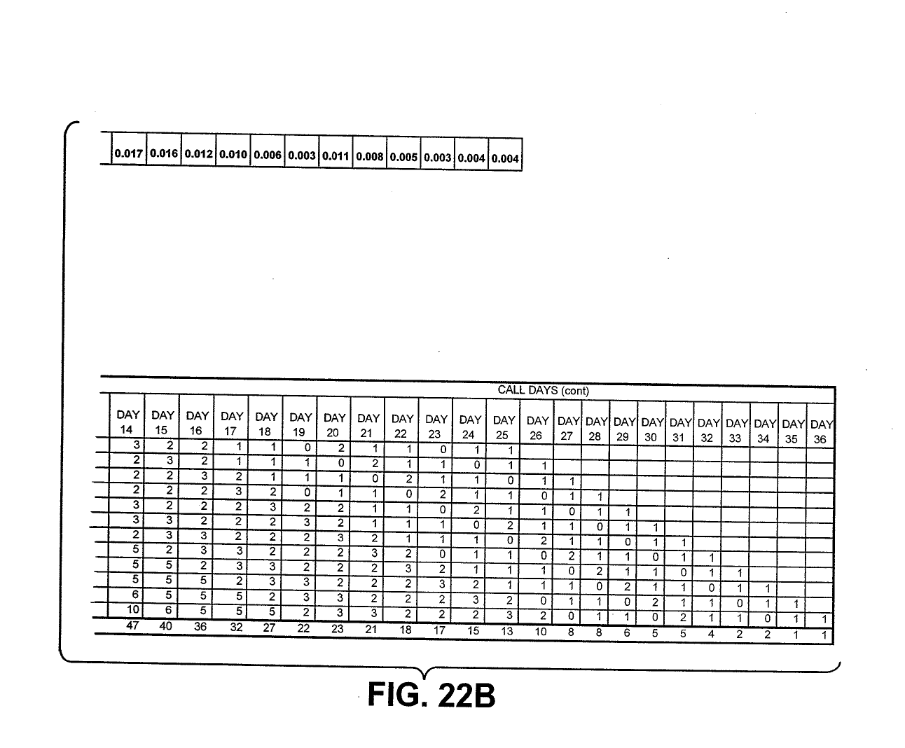

FIGS. 22A and 22B depict a table illustrating call center control results for a hypothetical example. The table also shows how the call center prediction algorithm will produce the desired call volume. BOX A shows the response delay curve, representing the distribution of responses to mail pieces arriving on a particular delay, where by the first response delay represents the responses on the day the mail piece arrives, and the second response delay represents the responses on the day after the mail piece arrives, and so on. This value is calculated based on historical call center response behavior as shown in FIG. 17, Step 2590.

The Call Center Control results are shown in BOX B, BOX C, and BOX D, as follows:

BOX B shows the response rate (R), representing the amount of calls that are generated from a number of responses. This value is calculated based on historical call center response rates as shown in FIG. 17, Step 2580.

BOX C shows the sum of response delays (S), representing the total amount of responses that will be generated during the resultant mailing campaign's in home curve. That is, if the mailing campaign needs to be 12 days long, then the first 12 response delays are added.

BOX D shows the desired call volume and the calculated daily mail piece volume that needs to be sustained for the length of the campaign (12 days in this case) in order to produce the desired call volume (100 calls in this case). The required daily mail piece volume is calculated by applying the formula:

Mail piece volume=(desired call volume)/(R×S)

The Call Center Prediction results indicate the call volume that would be generated if a mailing campaign with the specified length and call volume were executed. The columns on the left show each day in the mailing campaign, totaling 12 days, and the mail piece volume for each day (471,256 pieces), and the predicted calls for each day (144). The section on the right shows the call distribution by applying the response delay curve (BOX A) for each day. The call distribution curve at the bottom shows the distribution of calls starting on DAY 1 of the campaign and ending 36 days after DAY 1.

BOX E shows the point when the call center volumes peak at the desired number of calls (100). It is important to note that the call distribution will have ramp up and ramp down stages. The call volume will peak at the desired calls, as shown, and the ramp up stage will produce volumes near the desired call volume. This indicates that the process can be tuned to sustain the desired call volume, within a range, for a number of days.

It is important to note that the Figs. omit the mailing campaign's ramp up and ramp down stages, which in turn will produce calls into the call center. These elements have been omitted because their impact would be minimal and for simplification purposes. Nevertheless, the algorithm can compensate by using historical ramp up and ramp down results to project and adjust mail piece volumes.

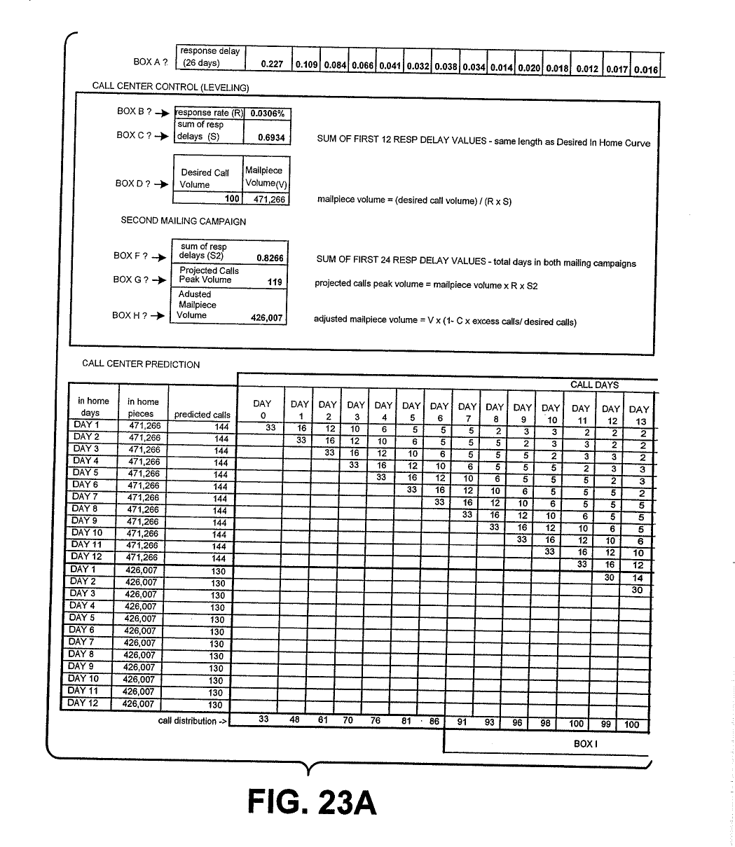

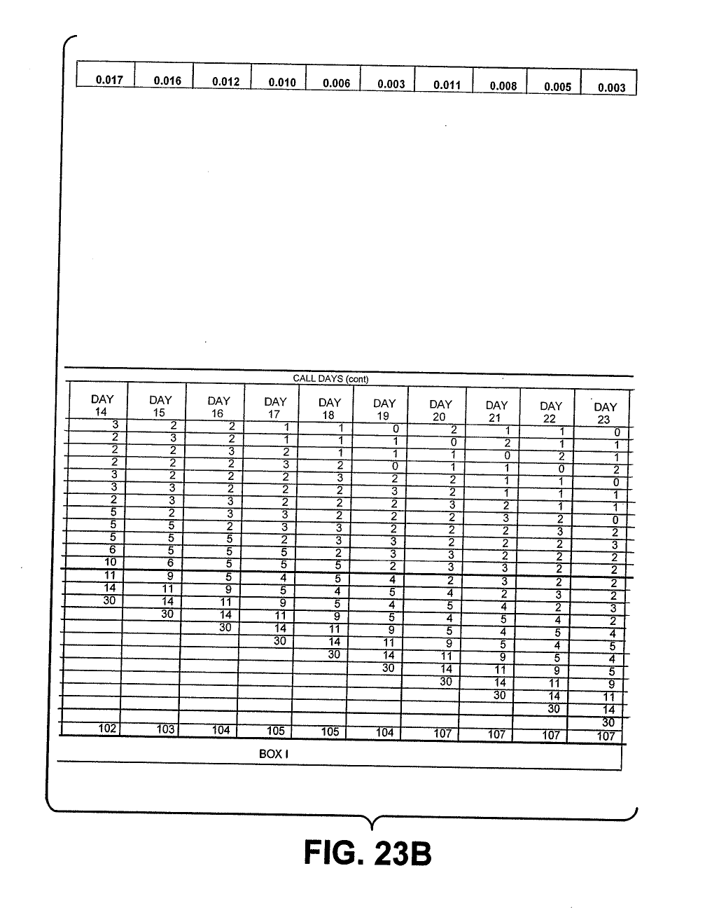

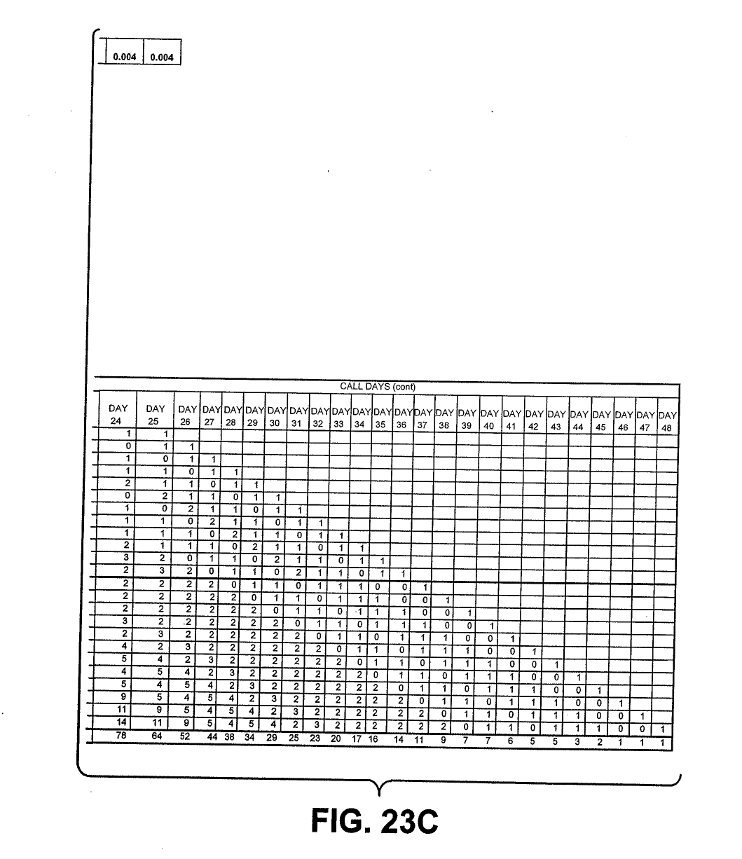

FIGS. 23A, 23B and 23C depicts a table illustrating call center control, where call volumes are sustained for longer periods of time using multiple campaigns, or a single campaign that is divided into different periods. The table also shows how the call center prediction algorithm will produce the desired call center volumes.

BOX A, shows the response delay curve, representing the distribution of responses to mail pieces arriving on a particular delay, where by the first response delay represents the responses on the day the mail piece arrives, and the second response delay represents the responses on the day after the mail piece arrives, and so on. This value is calculated based on historical call center response behavior as shown in FIG. 17, Step 2590.

The Call Center Control (Leveling) results are shown in BOX B, C, D, F, G, H, as follows:

B, C, D mail piece volume (V) BOX B shows the response rate (R), representing the amount of calls that are generated from a number of responses. This value is calculated based on historical call center response rates as shown in FIG. 17, Step 2580.

BOX C shows the sum of response delays (S), representing the total amount of responses that will be generated during the resultant mailing campaign's in home curve. That is, if the mailing campaign needs to be 12 days long, then the first 12 response delays are added.

BOX D shows the desired call volume and the calculated daily mail piece volume that needs to be sustained for the length of the campaign (12 days in this case) in order to produce the desired call volume (100 calls in this case). The required daily mail piece volume is calculated by applying the formula:

Mail piece volume=(desired call volume)/(R×S)

The control for the second mailing campaign or second part of the mailing campaign is shown in BOX F, BOX G, and BOX H. BOX F shows the sum of response delays for the total length of days spanned by the two mailing campaigns. In this case, 24 days, 12 days for each mailing campaign.

BOX G shows the projected peak call volume if the same mail piece volume would be used for the second mailing campaign, 119 calls in this case. The projected call peak volume is calculated as follows:

projected calls peak volume=(mail piece volume)/(R×S)

BOX H shows the adjusted mail piece volume for the second campaign that will produce the desired calls, by reducing the projected peak call volume appropriately. The adjusted mail piece volume is calculated using the following formula:

adjusted mail piece volume=V×(1−C×excess calls/desired calls)

where the excess calls is the peak call volume—desired call volume and C is a constant used to scale the adjustment.

The call center prediction section shows results similar as those in FIGS. 22A and 22B, but for two campaigns. The columns on the left show the days for the two campaigns, where the second mailing campaign volumes start one day after the first mailing campaign volumes end. The in home pieces column also shows the mail piece volumes for each day, as calculated in BOX D and BOX H above, and the projected calls column shows the projected calls for each day.

The section on the right shows the projected calls for the first mailing campaign, followed by the second mailing campaign and indicates how as the calls for the first mailing campaign ramp down, the calls for the second mailing campaign ramp up. The total call volume that is generated shows how the desired call volume is sustained for a period of 10 days after the first mailing campaign completes. In total, call center volumes are maintained at near the desired call volume for 17 days, as shown in BOX I.

It is important to note that this process can be used repeatedly to sustain call center volumes indefinitely.

It is important to note that the Figs. omits the mailing campaign's ramp up and ramp down stages, which in turn will produce calls into the call center. These elements have been omitted because their impact would be minimal and for simplification purposes. Nevertheless, the algorithm can compensate by using historical ramp up and ramp down results to project and adjust mail piece volumes.

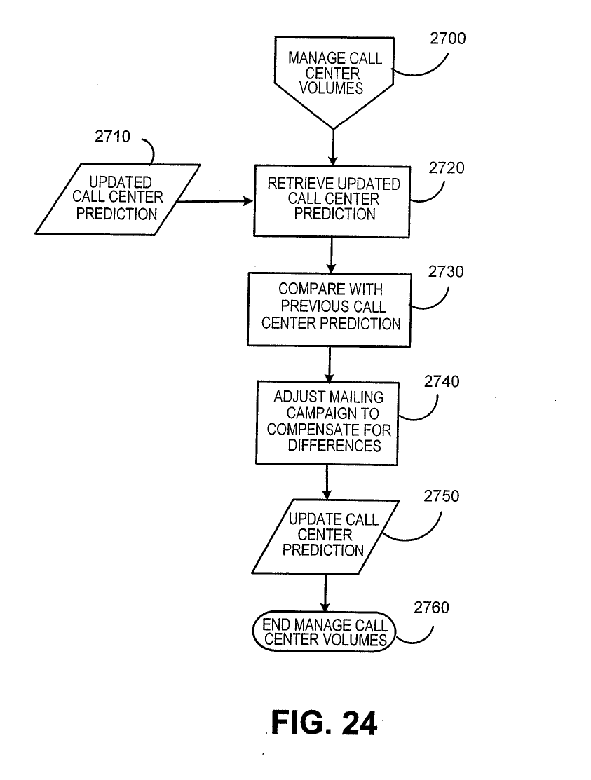

FIG. 24 is a flowchart showing how call center volumes can be dynamically controlled in order to maintain desired call volumes throughout the length of a mailing campaign as illustrated in FIGS. 22A and 22B. This process can also be applied to multiple mailing campaigns to dynamically maintain desired call center volumes as illustrated in FIGS. 23A and 23B.

The process starts in step 2700, Manage Call Center Volumes and continues in step 2720 where the Updated Call Center Prediction is retrieved from step 2710, Updated Call Center Prediction. The Updated Call Center Prediction is calculated by performing the process depicted in FIG. 16, Predict Call Center Volumes, and will include actual results to date and predicted results for mail pieces that have not yet been received by a recipient.

The process continues with step 2730 where the Updated Call Center Prediction and the previous call center prediction are compared. This step determines if call center volumes are falling below or rising above the volumes originally targeted when the call center control was first performed, or if there is a new target that requires the call center volumes to be increased or reduced.

Next, in step 2740, the Mailing Campaign is adjusted to compensate for the differences determined in step 2730 above. The adjustments can consist of changing induction dates, facilities where shipments are inducted, or even rearranging shipments as needed to change mail piece daily volumes in order to generate the call volumes being targeted.

The process continues in step 2750, where the Call Center Prediction is updated once again, to show the new projected call volumes that take into account the changes made to the Mailing Campaign. This is done by performing the process shown in FIG. 16, Call Center Prediction.

Finally, the process ends in step 2760, end Manage Call Center Volumes.

It should be understood that although the present invention was described with respect to mail processing by the USPS, the present invention is not so limited and can be utilized in any application in which mail is processed by any carrier. The present invention may also be utilized for mail other than direct marketing mail, for instance, transactional mail, i.e., bills, charitable solicitations, political solicitations, catalogues etc. Also the expression “in-home” refers to the recipient's residence or place of business.

The above specification describes a new and improved method for controlling call center volumes. It is realized that the above description may indicate to those skilled in the art additional ways in which the principles of this invention may be used without departing from the spirit. Therefore, it is intended that this invention be limited only by the scope of the appended claims.

What is claimed is:

1. A method utilizing a computer to vary resources at a call center based upon predicted call center volume, the predicted call center volume being associated with a mailing campaign including (i) a plurality of mailpieces, each mailpiece containing an offer/solicitation, (ii) desired induction dates for delivering each of the mailpieces to a mail recipient, and (iii) historical data in connection with one or more past mailing campaigns, the method comprising the steps of:
calculating an in-home curve, based upon the historical data, predicting a receipt date when each of the plurality of mailpieces for a particular mailing campaign will be delivered to each of the mail recipients based upon one or more desired induction dates;
calculating a predicted call center volume, based upon the historical data and in-home curve, for predicting the quantity of respondents and a time delay for the respondents to contact the call center following the receipt date of the mailpiece;
determining an actual call center volume, based upon the current call center volume in connection with the mailing campaign; and
determining a level of resources required by a call center based upon a difference between the actual and predicted call center volumes.

2. The method according to claim 1 further including the step of varying the staffing at the call center based upon the difference in actual and predicted call center volumes

3. The method according to claim 1 wherein the step of calculating an in-home curve includes the steps of determining an in-home window predicting a range of dates when each of the mailpieces will be delivered to each of the mail recipients and wherein the step of calculating a predicted call center volume includes the step of predicting a date range over which the respondents will contact the call center.

4. The method according to claim 1 further including the step of collecting data in connection with the actual call center volume for the mailing campaign, and wherein the step of calculating predicted call center volume includes the step of integrating the collected data with the historical data.

5. The method claimed in claim 1, wherein a mailing campaign control algorithm is used to determine an in-home mail volume for one or more of the induction dates. volumes.

6. The method claimed in claim 5, wherein the mailing campaign control algorithm determines the in-home mail volume by dividing the number of desired calls by the response rate multiplied by the sum of the time delays for each of the responses.

7. The method claimed in claim 5, wherein the mailing campaign algorithm is operative to level call center volumes when conducting a plurality of mailing campaigns.

8. The method claimed in claim 1, wherein the historical data for a mailing campaign includes a day of a week in which the mail piece is delivered to the recipient.

9. The method claimed in claim 1, wherein the historical data for a mailing campaign includes a season in which the mail piece is delivered to the recipient.

10. The method claimed in claim 1, wherein the historical data for a mailing campaign includes a geographic region of the country in which the mailpiece is delivered to the recipient.

11. The method claimed in claim 1, wherein the historical data for a mailing campaign includes the weather when the mail piece is delivered to the recipient.

12. The method claimed in claim 1, wherein the mailing campaign data includes a facility condition of all the mail facilities the mail piece traveled through before the mail piece is delivered to the recipient.
